(19) United States
(12) Patent Application Publication
(10) Pub. No.: US 2026/0187358 A1
(43) Pub. Date: Jul. 2, 2026

(54) METHODS AND SYSTEMS FOR UNION COMBINING AND FURTHER MANIPULATING DATA SETS IN A SPREADSHEET FUNCTION

(71) Applicant: ADAPTAM INC., Palo Alto, CA (US)

(72) Inventors: Robert E. DVORAK, Portola Valley, CA (US); Yuriy GARIN, San Carlos, CA (US); Alexey VERKHOVSKIY, Calgary (CA)

(73) Assignee: ADAPTAM INC., Palo Alto, CA (US)

(21) Appl. No.: 19/432,874

(22) Filed: Dec. 24, 2025

Related U.S. Application Data
(60) Provisional application No. 63/739,288, filed on Dec. 27, 2024.

(51) Int. Cl. G06F 40/18; G06F 7/36

(52) U.S. Cl. CPC G06F 40/18; G06F 7/36

(57) ABSTRACT

The disclosed technology creates spreadsheet prebuilt functions to union combine and sort data from two or more data sets from in-cell spreadsheet data and/or non-spreadsheet cell external data. Further embodiments then filter, limit and change the orientation of the data input or the data output.

### PRIORITY APPLICATION

This application claims the benefit of and priority to U.S. Provisional Application No. 63/739,288, filed 27 Dec. 2024, titled “METHODS AND SYSTEMS FOR UNION COMBINING AND FURTHER MANIPULATING DATA SETS IN A SPREADSHEET FUNCTION” (Atty. Docket No. ADAP 1022-1), which application is incorporated herein by reference.

### RELATED APPLICATIONS

This application is related to and incorporates by reference the following applications:

U.S. application Ser. No. 16/31,339 titled “Methods and Systems for Providing Selective Multi-Way Replication and Atomization of Cell Blocks and Other Elements in Spreadsheets and Presentations,” filed 10 Jul. 2018, now U.S. Pat. No. 11,182,548, issued 23 Nov. 2021 (Atty. Docket No. ADAP 1000-2), which claims the benefit of U.S. Provisional Application No. 62/530,835, filed 10 Jul. 2017 (Atty. Docket No. ADAP 1000-1).

U.S. application Ser. No. 16/31,379 titled “Methods and Systems for Connecting a Spreadsheet to External Data Sources with Formulaic Specification of Data Retrieval,” filed 10 Jul. 2018, now U.S. Pat. No. 11,354,494, issued 7 Jun. 2022 (Atty. Docket No. ADAP 1001-2), which claims the benefit of U.S. Provisional Application No. 62/530,786, filed 10 Jul. 2017 (Atty. Docket No. ADAP 1001-1).

U.S. application Ser. No. 16/31,759 titled, “Methods and Systems for Connecting a Spreadsheet to External Data Sources with Temporal Replication of Cell Blocks,” filed 10 Jul. 2018, now U.S. Pat. No. 11,17,165, issued 25 May 2021 (Atty. Docket No. ADAP 1002-2), which claims the benefit of U.S. Provisional Ser. No. 62/530,794 , filed 10 Jul. 2017 (Atty. Docket No. ADAP 1002-1).

U.S. application Ser. No. 16/191,402 titled, “Methods and Systems for Connecting a Spreadsheet to External Data Sources with Ordered Formulaic Specification of Data Retrieved,” filed 14 Nov. 2018, now U.S. Pat. No. 11,36,929, issued 15 Jun. 2021 (Atty. Docket No. ADAP 1003-2), which claims the benefit of U.S. Provisional Patent Application No. 62/586,719, filed on Nov. 15, 2017 (Atty Docket ADAP 1003-1).

U.S. application Ser. No. 17/359,430 titled, “Methods and Systems for Constructing a Complex Formula in a Spreadsheet Cell,” filed 25 Jun. 2021 (Atty Docket ADAP 1004-2), which claims the benefit of U.S. Provisional Patent Application No. 63/044,990 , filed 26 Jun. 2020 (Atty Docket No. ADAP 1004-1).

U.S. application Ser. No. 17/359,418 titled “Methods and Systems for Presenting Drop-Down, Pop-Up or Other Presentation of a Multi-Value Data Set in a Spreadsheet Cell,” filed 25 Jun. 2021, now U.S. Pat. No. 11,657,217, issued 25 May 2023 (Atty Docket No. ADAP 1005-2), which claims the benefit of U.S. Provisional Patent Application No. 63/044,989 , filed 26 Jun. 2020 (Atty Docket No. ADAP 1005-1).

U.S. application Ser. No. 17/384,404 titled “Method and System for Improved Spreadsheet Charts,” filed 23 Jul. 2021 (Atty Docket No. ADAP 1006-2), which claims the benefit of U.S. Provisional Patent Application No. 63/055,581 , filed 23 Jul. 2020 (Atty Docket No. ADAP 1006-1).

U.S. application . Ser. No. 17/374,898 titled “Method and System for Improved Spreadsheet Analytical Functioning,” filed 13 Jul. 2021, now U.S. Pat. No. 11,694,23, issued 4 Jul. 2023 (Atty Docket No. ADAP 1007-2), which claims the benefit of U.S. Provisional Patent Application No. 63/051,280 , filed 13 Jul. 2020 (Atty Docket No. ADAP 1007-1).

U.S. application Ser. No. 17/374,901 titled “Method and System for Improved Ordering of Output from Spreadsheet Analytical Functions,” filed 13 Jul. 2021 (Atty Docket No. ADAP 1008-2), which claims the benefit of U.S. Provisional Patent Application No. 63/051,283 , filed 13 Jul. 2020 (Atty Docket No. ADAP 1008-1).

U.S. application Ser. No. 17/752,814 titled “Method and System for Spreadsheet Error Identification and Avoidance,” filed 24 May 2022 (Atty Docket No. ADAP 1009-2) which claims the benefit of U.S. Provisional Patent Application No. 63/192,475 , filed 24 May 2021 (Atty Docket No. ADAP 1009-1).

U.S. application Ser. No. 17/988,641 titled “Methods and Systems for Sorting Spreadsheet Cells with Formulas,” filed 16 Nov. 2022 (Atty Docket No. ADAP 1011-2) which claims the benefit of U.S. Provisional Patent Application No. 63/280,590 , filed 17 Nov. 2021 (Atty Docket No. ADAP 1011-1).

U.S. application Ser. No. 18/074,301 titled “Method and System for Improved Visualization of Charts in Spreadsheets,” filed 2 Dec. 2022 (Atty Docket No. ADAP 1012-2) which claims the benefit of U.S. Provisional Patent Application No. 63/25,945, filed 3 Dec. 2021 (Atty Docket No. ADAP 1012-1).

U.S. application Ser. No. 18/142,560 titled “Methods and Systems for Spreadsheet Function and Flex Copy-Paste Control of Formatting and Use of Selection List Panels,” filed 2 May 2022 (Atty Docket No. ADAP 1013-2) which claims the benefit of U.S. Provisional Application No 63/337,576, filed 2 May 2022 (Atty Docket No. ADAP 1013-1).

U.S. application Ser. No. 18/142,557 titled “Methods and Systems for Bucketing Values in Spreadsheet Functions,” filed 2 May 2023 (Atty Docket No. ADAP 1014-2) which claims the benefit of U.S. Provisional Application No. 63/337,572, filed 2 May 2022 (Atty Docket No. ADAP 1014-1).

U.S. Provisional Application No. 63/433,408, titled “Methods and Systems for Flexibly Linking Spreadsheet Cell Movements and Formulas,” filed 16 Dec. 2022 (Atty Docket No. ADAP 1015-1).

U.S. Provisional Application No. 63/525,138, titled “Methods and Systems for Specifying and Using in Spreadsheet Cell Formulas Joins Between Data Sets,” filed 5 Jul. 2023 (Atty Docket No. ADAP 1016-1).

U.S. Provisional Application No. 63/529,135, titled “Methods and Systems for Specifying and Using Joins Between Data Sets In A Spreadsheet Data Visualizer,” filed 5 Jul. 2023 (Atty Docket No. ADAP 1017-1).

U.S. Provisional Application No. 63/622,515, titled “Methods and Systems for a Family of Dual Entry Spreadsheet Functions, Improved Spreadsheet Validations, and Partial Locking of Spreadsheet Functions and Cell Capabilities,” filed 18 Jan. 2024 (Atty Docket No. ADAP 1019-1).

### BACKGROUND

Today's spreadsheets have very limited capabilities to help users union combine and manipulate data from different sets of data (e.g., tables of data). Existing spreadsheet functions (e.g., VSTACK or HSTACK) can union combine (aggregate) one or more cell range data sets but not union combine non-spreadsheet cell external data sets and not union combine a combination of cell range data and non-spreadsheet cell external data. Those existing union combine spreadsheet functions only do the union combination of the data requiring other functions or activities to do the actions frequently desired by users of that combined data, such as sorting the combined data, filtering it, and limiting it to a specified number of outputs. Those union combine spreadsheet functions lack the ability to deal with data sets of different orientations (row major versus column major) and to have different orientations between the data set inputs and the data set outputs.

Accordingly, an opportunity arises to give spreadsheet users a one or more functions that supports a much fuller set of abilities to union combine data sets from different types of sources (e.g., spreadsheet cell and non-spreadsheet cell external data) and different orientations (row major versus column major), and then sort, filter, limit, and change orientation of the combined data output.

### SUMMARY

Embodiments of the disclosed technology give spreadsheet users one or more prebuilt spreadsheet function with the ability to union combine data sets from different types of sources, sources which are entirely non-spreadsheet cell external data sets, sources that are entirely from spreadsheet cell ranges, and sources both from non-spreadsheet cell external data sets and spreadsheet cell ranges. Embodiments that handle the different orientations (row major versus column major) of the spreadsheet cell data to allow for correctly combining data sets with different starting orientations. Then to automatically sort the combined data via default sort types, user specified sort types or a combination of default and user specified sort types. Embodiments that then filter, limit, and change orientation of the combined data output.

Particular aspects of the technology disclosed are described in the claims, specification, and drawings.

### BRIEF DESCRIPTION OF THE DRAWINGS

The included drawings are for illustrative purposes and serve only to provide examples of possible structures and process operations for one or more implementations of this disclosure. These drawings in no way limit any changes in form and detail that may be made by one skilled in the art without departing from the spirit and scope of this disclosure. A more complete understanding of the subject matter may be derived by referring to the detailed description and claims when considered in conjunction with the following figures, wherein like reference numbers refer to similar elements throughout the figures.

FIG. 1 examples prior art of Microsoft Excel sequential use of the VSTACK, FILTER, and SORTBY functions to union combine, sort and filter two in-spreadsheet cell data sets.

FIG. 2 examples prior art of Microsoft Excel sequential use of the VSTACK, SORTBY, and FILTER functions to union combine, sort and filter two in-spreadsheet cell data sets.

FIG. 3 examples prior art of two Microsoft Excel formulas different uses of the VSTACK, FILTER, and SORTBY functions to union combine, sort and filter two in-spreadsheet cell data sets.

FIG. 4 examples an embodiment of our technology union combining sorting and filtering in-spreadsheet cell data sets, like those in FIG. 1 through FIG. 3, with a single prebuilt spreadsheet function formula as well as a second example that then limits the output.

FIG. 5 illustratively examples partially or fully the automatically done actions by the formulas in FIGS. 4, 9, and 13. Noting some examples would skip step five and output the full list in step four and therefore partially example the automatically done actions not showing the removal of the column headings and the cell formatting that parallels what was done in step ‘6’.

FIG. 6 examples an embodiment of our union combine and sorting spreadsheet prebuilt function working for two in-spreadsheet cell data sets employing the minimum required two arguments.

FIG. 7 examples prior art of the Microsoft Excel required multifunction formula to deliver the same outcome as in FIG. 6.

FIGS. 8A and 8B examples two of many possible non-spreadsheet cell (NSC) external data sets employed by our technology.

FIG. 9 examples an embodiment of our prebuilt spreadsheet union combine and sort function technology also filtering and limiting values for two NSC external data sets.

FIG. 10 examples a similar formula as FIG. 9 without the limit argument and with the data in a different order within the formula.

FIG. 11 examples an embodiment of our union combine and sorting spreadsheet prebuilt function technology working for two NSC external data sets employing the minimum required two arguments employing our WRITE functions to access the NSC external formulaic data.

FIG. 12 illustratively examples the automatically done actions by the formula in FIGS. 11, 6, and 16.

FIG. 13 examples an embodiment of our prebuilt spreadsheet union combine and sort function technology also filtering and limiting values for one in-spreadsheet cell data set and one NSC external data set.

FIG. 14 examples an embodiment of our prebuilt spreadsheet union combine and sort function technology reorienting a horizontal in-spreadsheet cell data set and delivering both a vertically and horizontally oriented output.

FIG. 15 illustratively examples the automatically done actions by the formulas in FIG. 14.

FIG. 16 examples an embodiment of our union combine and sorting spreadsheet prebuilt function technology working for one in-spreadsheet cell data set and one NSC external data set employing the minimum required two arguments.

FIG. 17 examples an embodiment of our union combine and sorting spreadsheet prebuilt function technology working for one in-spreadsheet cell data set and two NSC external data sets employing the minimum required two arguments and one optional third data set argument.

FIGS. 18 and 19 illustratively examples the automatically done actions by the formula in FIG. 17.

FIG. 20 examples a union combine spreadsheet function where the in-spreadsheet cell data sets are not inputted as single ranges but inputted by a number of ranges and where the user employs the default sorts and none of the optional arguments.

FIG. 21 illustratively examples the automatically done actions by the formula in FIG. 20.

FIG. 22 examples a union combine spreadsheet function where the in-spreadsheet cell data sets are not inputted as single ranges but inputted by a number of ranges and where the user employs a combination of manual and default sorts and multiple constraints (filters).

FIG. 23 illustratively examples the automatically done actions by the formula in FIG. 22.

FIG. 24 depicts an example computer system that can be used to implement aspects of the technology disclosed.

### DETAILED DESCRIPTION

The following detailed description is made with reference to the figures. Example implementations are described to illustrate the technology disclosed, not to limit its scope, which is defined by the claims. Those of ordinary skill in the art will recognize a variety of equivalent variations on the description that follows.

When spreadsheet applications were first created, they electronically emulated tabular paper spreadsheets. More recently, Microsoft Excel, Google Sheets, Apple Numbers, and others have dramatically increased the breadth of capabilities and usefulness of spreadsheets. However, current spreadsheets do not allow users to union combine (aggregate) different data including external data in their regular spreadsheet cell formulas. The best they can do is employ a VSTACK or HSTACK function to union combine two or more sets of similarly oriented spreadsheet cell data ranges. There are no cell prebuilt functional formulas that union combine two or more non-spreadsheet cell external data sets nor union combine one or more spreadsheet cell data range data set with one or more non-spreadsheet cell external data sets. And there are no single functions that then allow a user to automatically execute additional actions on the union combined data including sorting, filtering, limiting, and reorienting the data set inputs or combined outputs vertically (row major order) or horizontally (column major order).

### Existing Spreadsheet Cell Formula Capabilities

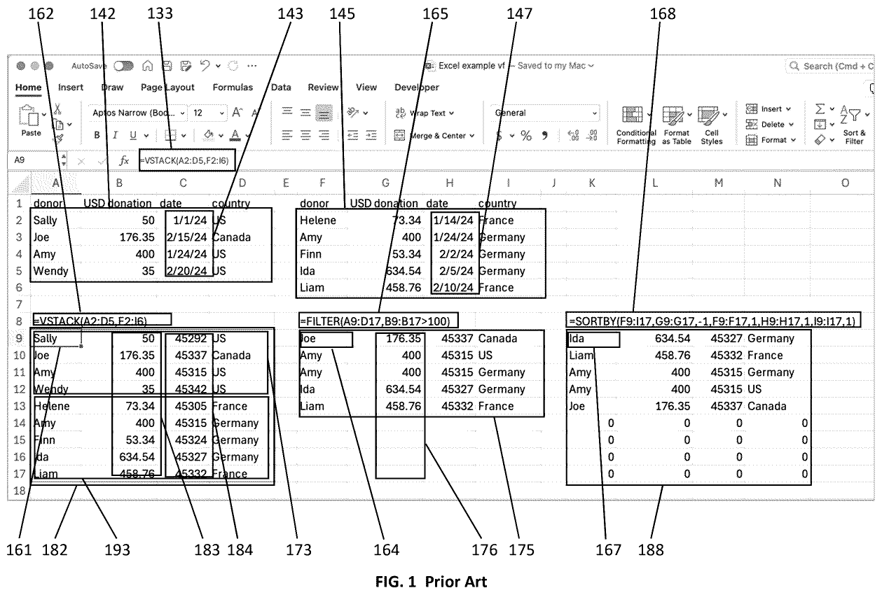

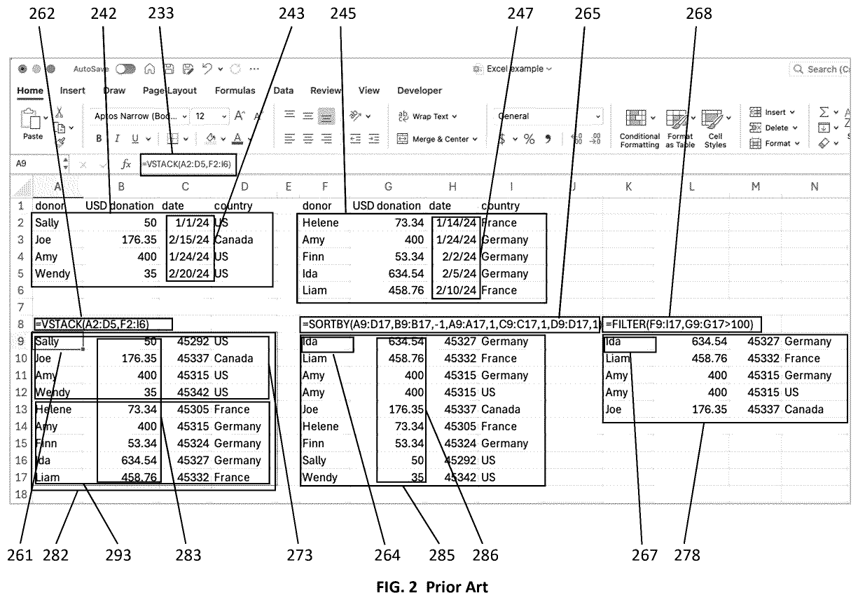

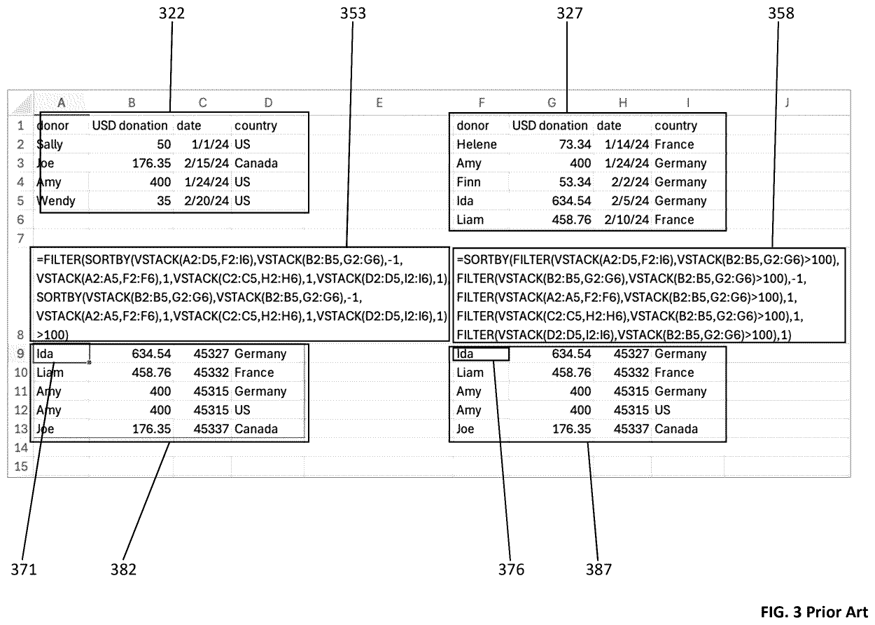

FIG. 1 and FIG. 2 example the current individual spreadsheet prebuilt functions that union combine (stack/aggregate) cell data sets and then the spreadsheet prebuilt functions that sort and filter individual data sets while FIG. 3 examples writing a single formula employing the three functions to union combine, filter and sort two spreadsheet cell ranges. In FIG. 3 the two different ways of writing a single formula employing the three functions to union combine, filter and sort two spreadsheet cell ranges requires some thought on how each function works, what ranges to use, and results in using the ‘VSTACK’ function ten times in each formula. Adding a limit requires additional actions by the user to more manually do it.

FIG. 1 examples the two in cell data sets (cell range A2:D5) 142 and (cell range F2:I6) 145 used in the Microsoft Excel prior art example. Note, Google Sheets works in a very similar manner and therefore is not separately exampled. We separately example the three different prebuilt functions used to union combine (‘VSTACK’ in Microsoft Excel and Google Sheets), sort (‘SORTBY’ in Microsoft Excel and SORT in Google Sheets), and filter (‘FILTER’ in Microsoft Excel and Google Sheets) before exampling their combined usage in FIG. 3. We start in FIG. 1 employing the ‘VSTACK’ function with the formula 133/162 (displayed using a FORMULATEXT function for the cell ‘A9’ 161) giving the result 182 which union combines the two data sets (142 and 145) in 173 and 193. This step needs to happen first, so the subsequent actions are done on the combined data sets, not each individual one. However, the order of applying those additional functions does have an impact in a generalized outcome, meaning one where the data can change and therefore the number of filter rows can change. This is because applying the filter second and the sort third results in the population of four rows of zeros (‘0’) in the final output 188 that are not displayed in the result applying the sort first and the filter second 278 in FIG. 2. In each of these scenarios there is a progression of the three functional formula outputs (182, 175 and 188) to get the results in FIG. 1 188 and the three functional formula outputs (282, 285 and 278) to get the results in FIG. 2 278. The three functional formulas (162/133, 165 and 168 in FIGS. 1 and 262, 265 and 268 in FIG. 2) are shown via the ‘FORMULATEXT’ formulas for the cells ‘A9’ 161, ‘F9’ 164, and ‘K9’ 167 in FIG. 1 and for the cells ‘A9’ 261, ‘F9’ 264, and ‘K9’ 267 in FIG. 2. Note, we us the FORMULATEXT function, or its equivalent, to display many of the formulas in our examples as well.

Each of those two examples in FIG. 1 and FIG. 2 starts with the ‘VSTACK’ formula 162/133 in FIGS. 1 and 262/233 in FIG. 2 which union combines the two data sets 173 (from 142) and 193 (from 145) in FIG. 1 and union combines the two data sets 273 (from 242) and 293 (from 245) in FIG. 2. The one problem that occurs in Microsoft Excel but not in Google Sheets is that the ‘VSTACK’ changes the dates 143 and 147 from the short date form to the numeric form 184 requiring reformatting of the cells to get back the short date form. In FIG. 1 the ‘FILTER’ function is then applied on the cells ‘A9:D17’ 182 to filtering using the values in cells ‘B9:B17’ 183 greater than ‘100’ to yield the filtered output 175. However, because the ‘SORT’ range can vary for each filter value (e.g., ‘>100’) the general case of the formula needs to anticipate the entire possible range ‘F9:I17’ and therefore generates the ‘0’ values in its output 188 when it sorts on ‘G9:G17’ values 176 descending (‘−1’) then followed by the other columns ascending (‘1’). These zeros ‘0’ are eliminated by reversing the order of the ‘FILTER’ and ‘SORT’ as was done in FIG. 2. In FIG. 2 the output 278 lacks the zeros ‘0’ because the ‘FILTER’ function does not generate them while still generally covering the entire possible output range of the ‘SORT’ function. However, the sorting has still been done in the same manner with ‘B1:B17’ 283 sorted descending (‘−1’) first followed by the other columns sorted ascending (‘1’). Then the filtering is done on the same relative column 286 of the combined data as in FIG. 1. So, not only does the user have to apply three functions with three results to get the desired outcome but they need to know what order to apply them to get the desired result without the extra zeros. And if the dataset increases in size, they need to adjust for that in all the subsequent formulas.

FIG. 3 examples two ways of employing the three existing spreadsheet prebuilt functions in single formulas to get the desired union combination sorting and filtering outcome (of the two in-cell data sets 322 and 327) recognizing there are many combinations of the three different functions that do not give the desired outcome. Both of the formulas 353/358 are quite complicated requiring ten ‘VSTACK’ functional formulas. The ‘FILTER’ function first formula 353 in cell ‘A9’ 371 employs two ‘SORTBY’ functional formulas each containing five ‘VSTACK’ functional formulas to deliver the result in cells ‘A9:D13’ 382. While the ‘SORTBY’ function first formula 358 in cell ‘F9’ 376 employs five ‘FILTER’ functional formulas each containing two ‘VSTACK’ functional formulas to deliver the result in cells ‘F9:I13’ 387. Given this requires combining many different functional formulas with other functional formulas, there is no single functional formula syntax to guide a user in developing these formulas. Thus, making it require substantial thought and prone to errors This is in contrast to our technology where for each different syntax embodiment there is a single correct function formula that delivers the desired outcome, e.g., the syntax:

$$COMBINE ( dataset 1 , dataset 2 , dataset 3 , … \vert constraint 1 , constraint 2 , … \vert SORT [ ] , LIMIT [ ] )$$

$$For the formula = COMBINE ( A 2 : D 5 , F 2 : I 6 \vert column 2 \{ > 100 \} \vert SORT [ column 2 \{ ! ZA \} ] )$$

Where ‘dataset1’ and ‘dataset2’ are the two required arguments. ‘dataset3’ is an optional argument not used here. ‘constraint1’ is an optional argument used here while ‘constraint2’ is an optional argument not used. ‘SORT’ is a named argument (as per our previous filings referenced herein) within the ‘COMBINE’ function rather than a sort function which is partially used here to specify a default override sort and ‘LIMIT’ is an optional named argument not used here. Thus, making the creation of the formula simply filling in the arguments (made even easier by our functional selection lists described in our U.S. application Ser. No. 17/752,814 titled “Method and System for Spreadsheet Error Identification and Avoidance,” filed 24 May 2022) rather than having to combine different functions in free form ways as required in the exampled prior art. Thereby not requiring the user to have to think through how to combine the functions to arrive at the desired outcome and risking that they combine them in incorrect ways. Also ending up in our technology with a much simpler functional formula. And as we will example herein our technology also supports union combining, sorting, filtering and further altering data sets from non-spreadsheet cell external data sources by themselves or in combination with in-cell data sets.

### Our Technology

Our technology provides a single function solution to the previously exampled union combine, sort, filter, and limit situations while also handling additional complications (e.g., cell data oriented different directions) and capabilities (e.g., output orientations not matching data set input orientations) for in-cell data sets. We will example embodiments employing different function syntaxes employing traditional spreadsheet function single delimiter (e.g., comma) arguments, employing spreadsheet function named arguments (containing one or more arguments within the named argument as described in our related application), and employing spreadsheet function argument groups (e.g., groups of arguments separated from another argument or group of arguments by a second delimiter as described in our related applications). We will also example how our technology is employed to execute the desired capabilities not only for in-spreadsheet cell data sets (e.g., ranges), but for multiple non-spreadsheet cell external data sets, and the combination of in-spreadsheet cell data set(s) and non-spreadsheet cell external data set(s).

### In-Cell Data Sets

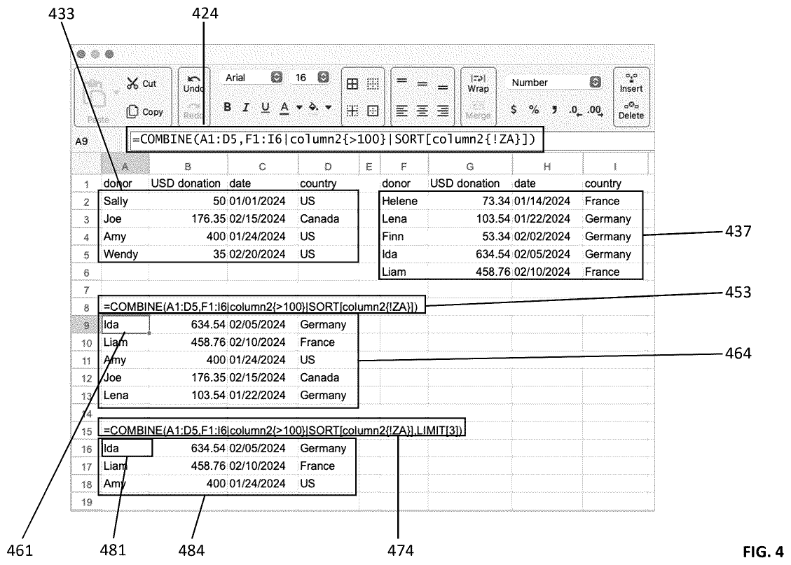

FIG. 4 examples two different usages of our technology union combining sorting and filtering in-spreadsheet cell data sets, like those in FIG. 1 through FIG. 3, with a single prebuilt spreadsheet function formula. The functional syntax, like spreadsheet functions has a defined set of arguments which in these examples employ argument groups (delimited by vertical bars ‘|’) and named argument(s). Some of the arguments are required and others are optional as indicated by the syntax below where the required arguments are bolded, and the optional characters and arguments are non-bolded:
Combine(dataset1,dataset2,dataset3, . . . |constraint1,constraint2, . . . |
SORT[], LIMIT[], INPUT[], OUTPUT[])

Two of the data set specifying arguments (‘dataset1,dataset2’) in the first argument group are required, additional data sets after that are optional and that argument group only holds data set specification arguments. In this embodiment the second argument group (constraint1,constraint2, . . . ) is entirely optional and are constraints (filters) specified by user which if not desired is omitted by ending the formula or leaving the argument group empty (‘∥’). The third argument group has a defined set of named arguments that therefore can be placed in any order and are all optional. The ‘SORT[]’ named argument is not the ‘SORT’ function but simply an optional argument if the user wants to override the ‘COMBINE’ function default sort, which in this embodiment is ascending sorts starting with the first “column” and working to the last “column” (thinking vertical output). The ‘LIMIT’ named argument is an optional limit without which all the values are outputted. The ‘INPUT’ named argument allows a user to override the typical vertical (rows major) data input default for in-spreadsheet cell data and specify horizontal (e.g., ‘H’) columns major in-spreadsheet cell orientation of one or more ‘datasetx’ input. And finally, the ‘OUTPUT’ named argument allows the user to override the default vertical (rows major) results output and specify a horizontal (e.g., ‘H’) columns major results output orientation. As previously mentioned, this is just one of the many syntaxes that our technology supports just as ‘COMBINE’ is just one of the various names our function or functions could be called (e.g., ‘UNION’, ‘VAGGREGATE’, ‘HAGGREGATE’).

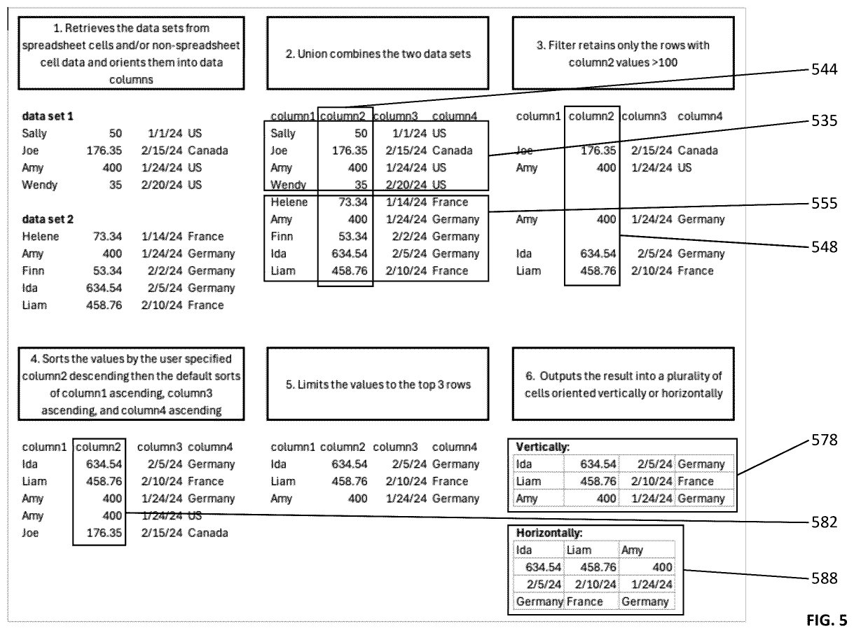

FIG. 4 examples two different formulas employing our technology to union combine the two in-spreadsheet cell data sets 433 and 437 and then sort and filter (constrain) the combined data. The formula 424/453 in the cell ‘A9’ 461 delivers the values in cells ‘A9:D13’ 464 while the formula 474 for the cell ‘A16’ 481 goes farther to ‘LIMIT’ the results to the top 3 rows for a vertical output (rows major) which it delivers in the cells ‘A16:D18’ 484. The function for the formula in cell ‘A16’ 481 is automatically executing the six steps illustratively exampled in FIG. 5. Where the first step retrieves the two data sets and ensures that they are both similarly oriented. Where the second step union combines the two data sets 535 and 555. The third step then filters (constrains) the data retaining only data where the value in the ‘column2’ is greater than ‘100 (544 before/548 after). Step four then sorts the data first by the user specified ‘column 2’ 582 ascending (‘SORT[column 2{!ZA}]’ in the formula 424/453 in FIG. 4) and then by the default sorts of column1 ascending, column3 ascending, and column4 ascending. Step five then limits the results to the top three (‘3’) rows, which was not done by the formula 424/453 in cell ‘A9’ 461 in FIG. 4. And finally step six outputs the results with the default or user desired override orientation. In this example employing the default vertical (rows major) orientation 578, however had the user specified the horizontal (columns major) orientation they would have received 588. The user did not need to decide how to combine different functions in different ways to get the desired outcome and risk getting an incorrect outcome. They complete the functional formula with a syntax as a guide, as well as supporting selection list hints, making it easy for the user to complete the formula. They do not have to contemplate how to combine different functions and correctly nest those functions within arguments of other functions.

While we could example all the different argument driven variants for in-spreadsheet cell data set application of our ‘COMBINE’ prebuilt spreadsheet functions, for brevities sake we will example those across the different data set combinations and instead simply example the simplest situation where the user opts to employ all default optional arguments in an example embodiment.

### Simplest In-Cell Datasets Example

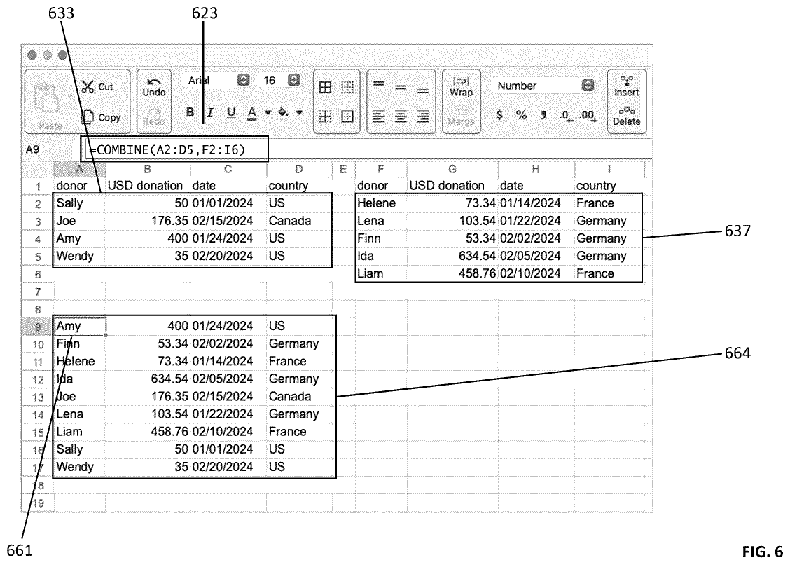

FIG. 6 examples a union combine spreadsheet function where the user employs the default sorts and none of the optional arguments. It could employ many different syntax variants from the traditional spreadsheet single delimiter fixed location arguments to syntaxes using named arguments and argument groups. One such syntax using the traditional spreadsheet comma delimited functional arguments is:
COMBINE(dataset1,dataset2,filter1,filter2,sortcolumn #, sort, limit, input1,input2,output)

### Where:

dataset1,dataset2 are required inputs of in-cell ranges (or external data sets or one in-cell and one external data set in later embodiments).
filter1,filter2 are optional arguments specifying the column and the filter/constraint (e.g., filter1 of column2>100 and filter2 of column3<‘2/1/24’).
sortcolumn # is an optional argument with the number of the column the user wants to override the default sort and make the first sort.
sort is 1 for ascending sort of the previous argument specified column number and −1 for descending.
limit is an optional argument overriding the default output of all data by a specified number of rows (rows major output) or columns (columns major output).
input1,input2 are optional arguments allowing the user to input H for horizontal orientation of that dataset input (with vertical as the default).
output is an optional argument allowing the user to override the default of vertical output (rows major) of the results by specifying H to get a horizontal output (columns major)

However, another syntax is the one already described herein employing argument groups and named arguments. Our technology supports a range of defined function syntaxes employing any combination of regular comma delimited arguments, named arguments, and/or argument groups.

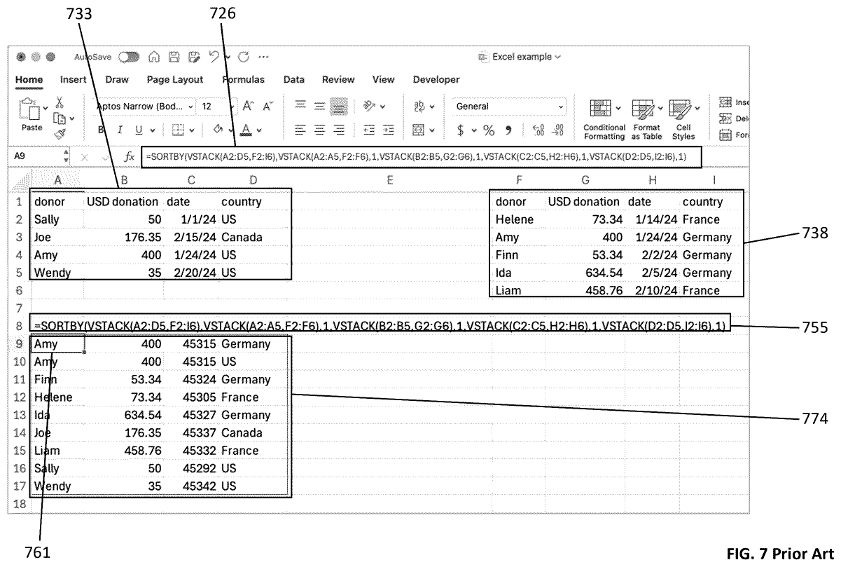

FIG. 6 examples the minimum argument in-spreadsheet cell sourced data sets application of our union combine (and sorting) function. The user employs the ‘COMBINE’ functional formula 623 in the cell ‘A9’ 661 to union combine and then default sort the two in cell range data sets 633 and 637 giving the results in cells ‘A9:D17’ 664. The simplicity of the formula is in contrast to the multi-function formula 726/755 in cell ‘A9’ 761 in FIG. 7 to deliver the same outcome 774 union combining and then sorting the same data ranges (733 and 738) in the Microsoft Excel spreadsheet. Contrasting a single function formula with our technology versus a six-function combination functional formula in the existing technology:

$$= COMBINE ( A 2 : D 5 , F 2 : I 6 )$$

$$versus$$

$$= SORTBY ( VSTACK ( A 2 : D 5 , F 2 : I 6 ) , VSTACK ( A 2 : A 5 , F 2 : F 6 ) , 1 , VSTACK ( B 2 : B 5 , G 2 : G 6 ) , 1 , VSTACK ( C 2 : C 5 , H 2 : H 6 ) , 1 , VSTACK ( D 2 : D 5 , I 2 : I 6 ) , 1 )$$

Where changing ranges in our technology is as simple as changing one argument, while changing ranges in the existing technology requires many different coordinated changes opening the opportunity for errors.

### Column by Column In-Cell Datasets Example

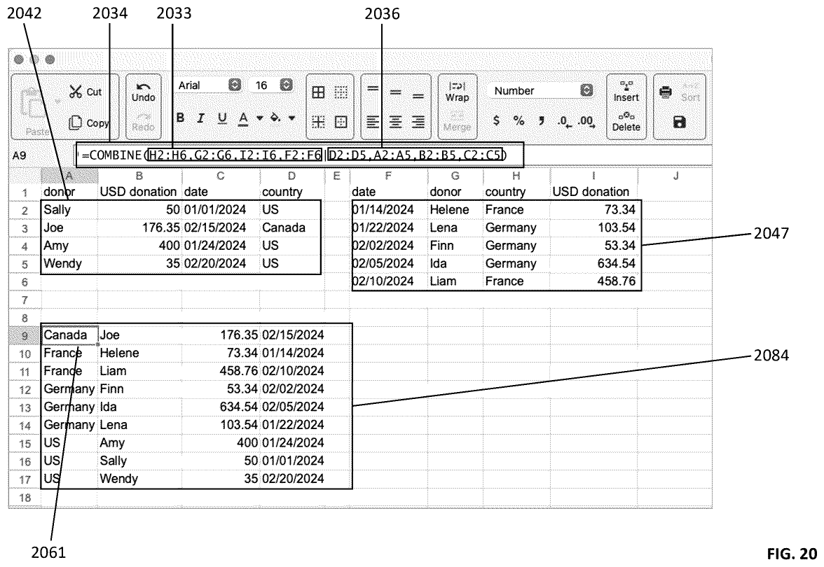

FIG. 20 through FIG. 23 example union combinations of in-spreadsheet cell data where the in-spreadsheet cell data sets are not inputted as single ranges but inputted by a number of ranges. Those ranges can be one range per column (in the row major vertical orientation) or one range per row (in the column major horizontal orientation). They can also be ranges of adjoining cells mixed with then other non-adjoining cell ranges. All of this allows a user to order the data in a manner different than it is ordered in the source data set or data sets.

FIG. 20 examples a union combine spreadsheet function where the user employs the default sorts and none of the optional arguments. It could employ many different syntax variants from the traditional spreadsheet single delimiter fixed location arguments to syntaxes using named arguments and argument groups. One such syntax using our functional named arguments and argument groups is:

$$COMBINE ( d1\_range1 , d1\_range2 , ... \vert d2\_range1 , d2\_range2 , ... \vert constraint 1 , … \vert sort 1 , … \vert option 1 , … )$$

### Where:

d1_range1 is a required input of an in-cell range (or external data set field in later embodiments) in the first argument group and d1_range2, . . . are optional inputs of in-cell ranges (or external data set fields in later embodiments).
d2_range1 is a required input of an in-cell range (or external data set field in later embodiments) in the second argument group and d2_range2, . . . are optional inputs of in-cell ranges (or external data set fields in later embodiments).
constraint1, . . . are optional arguments in the third argument group specifying the column and the filter/constraint (e.g., constraint1 of column2>100 and constraint2 of column3<‘2/1/24’).
sort1, . . . are optional arguments with the number of the column (or row) the user wants to override the default sort and make the first sort and any subsequent sort.
option1, . . . are optional arguments including named arguments like LIMIT[] which overrides the default output of all data by a specified number of rows (rows major output) or columns (columns major output), INPUT[] an optional argument(s) allowing the user to input H for horizontal orientation of that dataset input (with vertical as the default), and OUTPUT[] an optional argument allowing the user to override the default of vertical output (rows major) of the results by specifying H to get a horizontal output (columns major)
   However, other syntaxes are supported for our technology for the individual column/row input of in-spreadsheet cell data sets and are compatible with our embodiments described later for using non-spreadsheet cell external data sets.

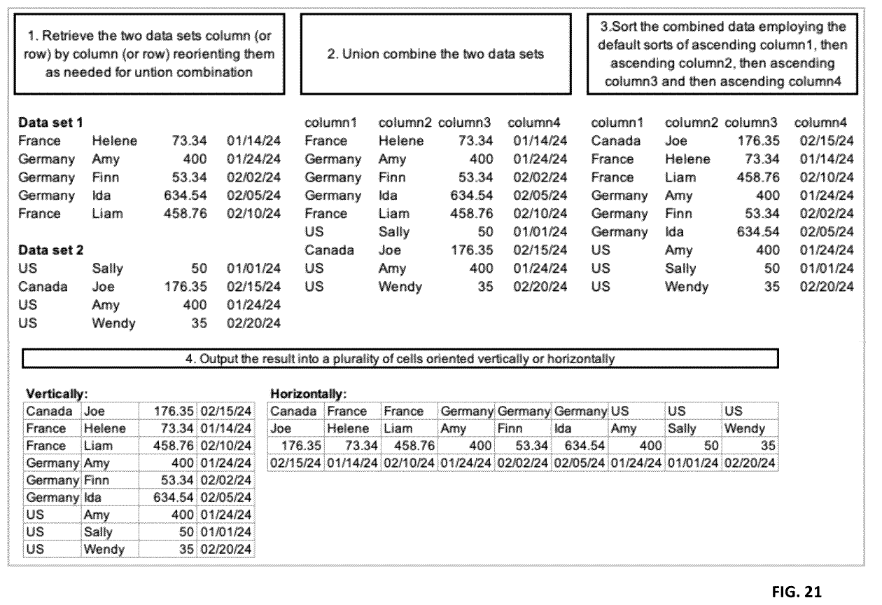

The union combine formula 2034 in FIG. 20 examples four cell ranges composing the data set 1 input 2033 and then four different cell ranges composing the data set 2 input 2033. The data set 1 input 2033 inputs are for the data in cells ‘F2:I6’ 2047 but have been rearranged as per the ‘H2:H6,G2:G6,I2:I6,F2:F6’ 2033 input while the data set 2 inputs ‘D2:D5,A2:A5, C2:C5,D2:D5’ 2036 have sourced the data in ‘A2:D5 ’ 2042 while rearranging it to match data set 1 and give the order preferred by the user for output 2084. Our technology then automatically executes the steps illustratively exampled in FIG. 21 for the formula 2034 for the cell ‘A9’ 2061 in FIG. 20 generating the results in ‘A9:D17’ 2084. Step one in FIG. 21 constructs the data column by column (or row by row) of the two data sets orienting if specified by the user for the union combination. Steps two then union combines the two data sets. Step three then in this example executes the embodiment default sort which is an ascending multi-sort starting with column1 working through all the columns, in this example four. Step four then outputs the results either vertically (rows major) or horizontally (columns major) into the cells ‘A9: D17’ 2084 in FIG. 20. In this embodiment employing the default vertical orientation.

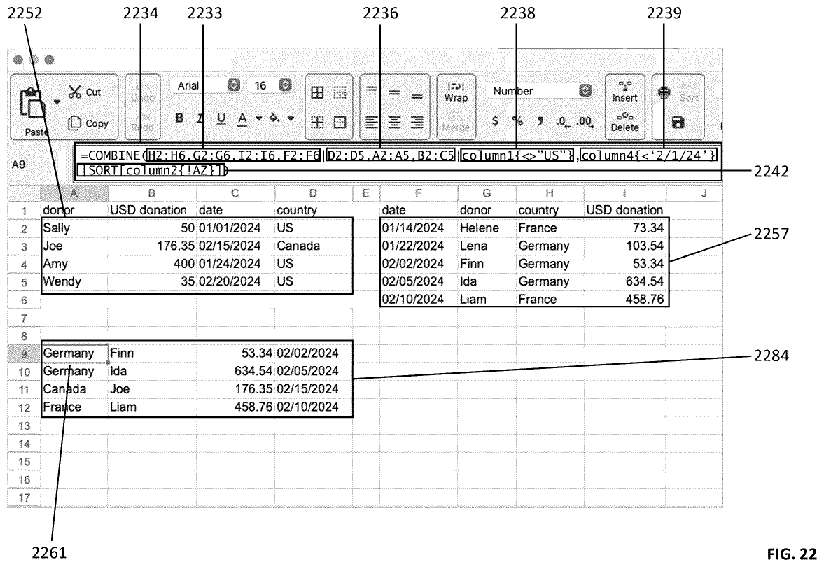

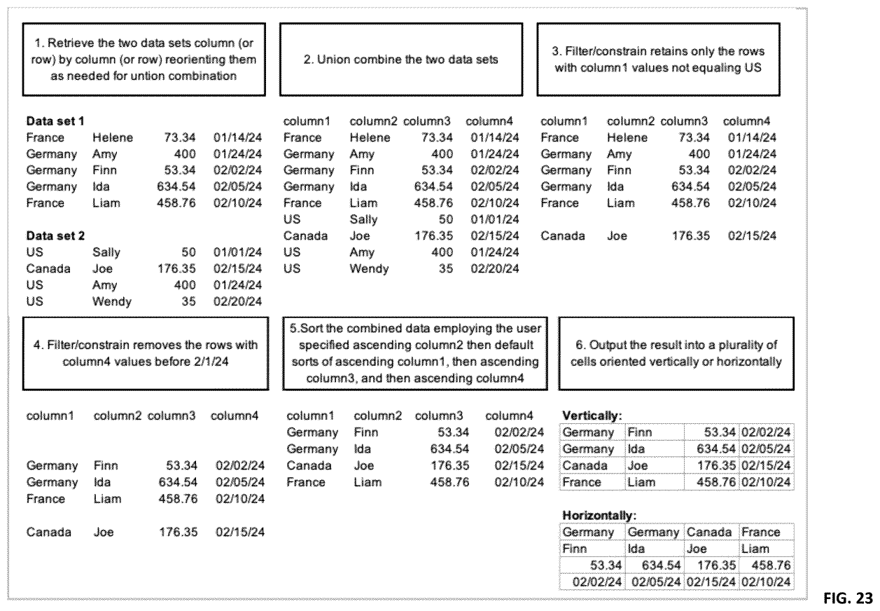

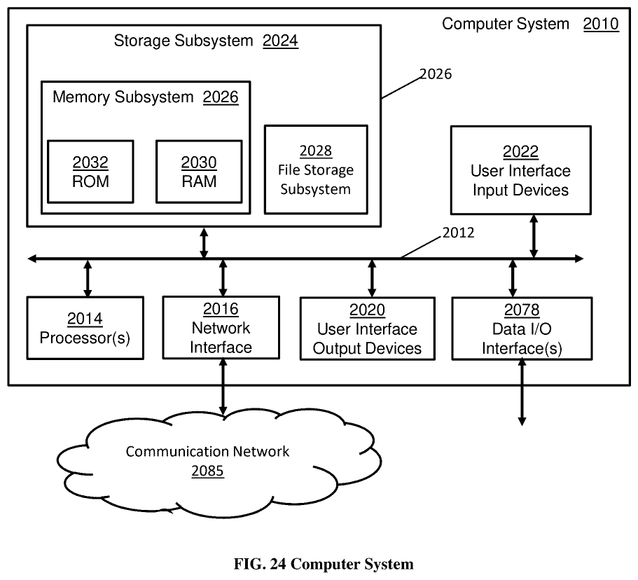

FIG. 22 and FIG. 23 examples the same embodiment as in FIG. 20 and FIG. 21 employed for an example employing constraints (filters) and a non-default sort. The in-spreadsheet data set sources 2257 and 2252 are the same as FIG. 20 and FIG. 21, and the first formula 2234 input 2233 is also the same, however the user this time takes advantage of the adjacency in the input of the second data set by collapsing ‘B2:B5,C2:C5’ in 2036 and FIG. 20 to just ‘B2:C5’ in 2236. Otherwise, the in-spreadsheet cell inputs are the same and they supply the same data. However, in this example the user has added two constraints/filters 2238 and 2239 in the third argument group and one sort 2242 in the fourth argument group. They have not added any of the options but could have. The end result for the formula the formula 2234 in cell ‘A9’ 2261 is the results in ‘A9:D12’ 2284. Those results are automatically generated by the illustrative steps in FIG. 23. Step one in FIG. 23 constructs the data column by column (or row by row) of the two data sets orienting if specified by the user for the union combination, with one specification here so employing the default of vertical. Steps two then union combines the two data sets. Step three then removes the rows containing a column1 value of ‘US’ while step four removes all the rows with a column4 date before ‘2/1/24’. Step five then overrides the first sort with an ascending sort (‘!AZ’) of column2 followed by the default sorts of column1, followed by column3 ascending and then column4 ascending (in this embodiment). Step six then outputs the results vertically (rows major) into the cells ‘A9:D12’ 2284 in FIG. 22.

While we could example different syntax, data set, and argument value examples for brevity's sake we will move on to exampling our technology for NSC external data sets.

### NSC External Data Examples

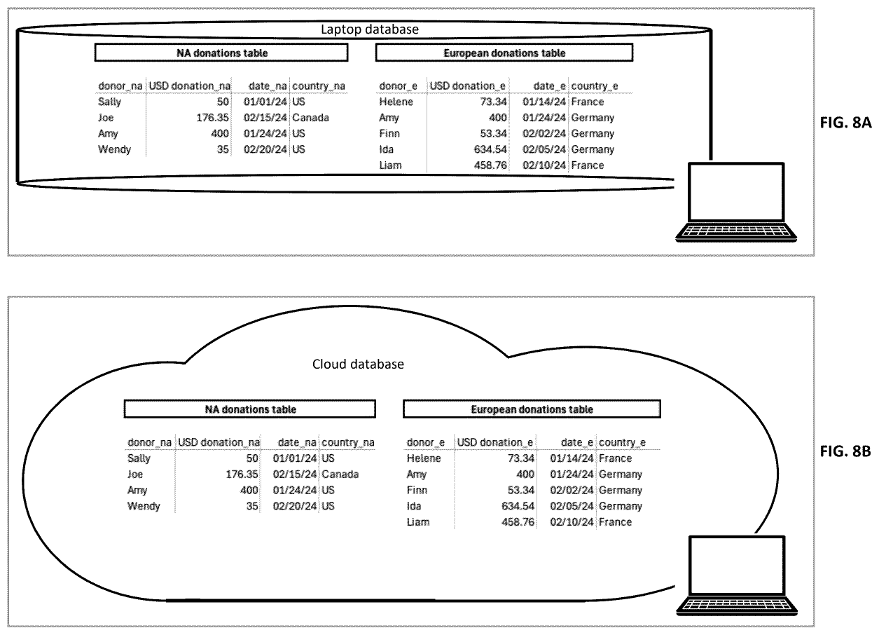

FIG. 8A through FIG. 17 examples capabilities for which there are no existing spreadsheet functional formula equivalents, no matter how many functions are involved, union combining (and sorting etc.) non-spreadsheet cell (NSC) external data sets and combinations of non-spreadsheet cell external data set(s) and in-spreadsheet cell data set(s).

### All NSC External Data Examples

FIG. 8A through FIG. 8B examples the two data sets like those we have used in the previous examples except residing in our NSC external data sets which are usable via our formulaic data in our spreadsheet technology as exampled in our referenced fillings. They are just two examples of where the NSC external data can reside with FIG. 8A exampling the two data sets residing on a user's laptop computer and FIG. 8B exampling the two data sets residing in one or more cloud database. In these examples the individual columns of data within the data sets have unique formulaic data field names (column names) thereby not requiring additional table pathway identifiers or table labels to uniquely identify them (although our technology supports those embodiments as well).

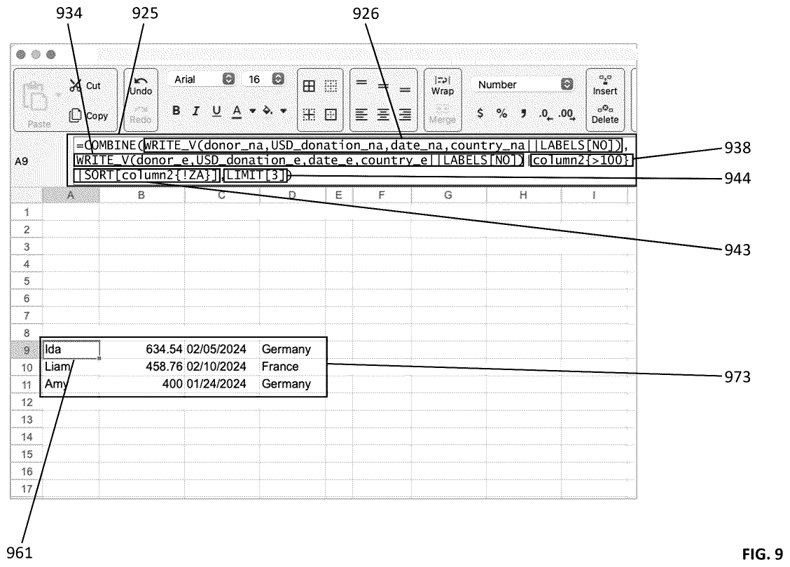

FIG. 9 examples the user doing the same union combine, sort and filter previously exampled (for in-spreadsheet cell data sets) except this time employing data that does not reside within their spreadsheet cells. The example employs a syntax using argument groups and named arguments similar to one previously described herein, however our technology supports many different syntaxes and ways of accessing the external data as we describe and example herein. In this example the NSC external data is populated in the ‘COMBINE’ functional formula 925 employing our table generator functions (e.g., ‘WRITE_V’) which employ our formulaic data fields to access the desired data. One ‘WRITE_V’ is employed to access the desired NSC external columns of data in each of dataset1 (926) and dataset2 (934). The filtering is done by the constraint1 argument ‘column2>100’ 938, the manually specified override of the first sort is done by the option1 named argument ‘SORT[column 2 {!ZA}]’ 943 and the limit of three rows is done by the named argument ‘LIMIT[3]’ 944 for the formula 925 populated in the cell ‘A9’ 961. It populates the same values 973 as our previous in-spreadsheet cell example 464 in FIG. 4. The automatically executed actions are exampled in FIG. 5, which was written for any data source, and the step descriptions are not repeated for brevity's sake.

As previously mentioned, the same result is supported by different embodiments of our technology employing different ways to access the NSC external data and different union combine function syntaxes. One such syntax is employs argument groups for each dataset and then a combination of additional argument groups and fixed location arguments as exampled below:
COMBINE(d1_field1,d1_field2, . . . |d2_field1,d2_field2, . . . |d3_field1,d3_field2, . . . |filter1,filter2,sortcolumn #, sort, limit, output)
   Where in this embodiment:
d1_field1 is the first data set required input of NSC external datasets formulaic data field

followed by any number of additional optional first data set formulaic data fields (e.g., d1_field2, . . . ).
d2_field1 is the second data set required input of NSC external datasets formulaic data field followed by any number of additional optional second data set formulaic data fields (e.g., d2_field2, . . . ).
d13_field1,d3_field2, . . . are the third data set optional inputs of NSC external datasets formulaic data fields.
filter1,filter2 are two optional arguments each specifying the column and the filter/constraint (e.g., column2>100,column_3<‘2/1/24’).
sortcolumn # is an optional argument with the number of the column the user wants to override the default sort and specify the first sort.
sort is and optional argument accompanying the sortcolumn # specified with a value of 1 for ascending sort and −1 for descending sort by those sortcolumn # values.
limit is and optional argument overriding the default output of all data by a specified number of rows (rows major output) or columns (columns major output).
output is an optional argument allowing the user to override the default of vertical output (rows major) of the results by specifying H to get a horizontal output (columns major).
   Note this syntax could have been made using all single delimiters by setting a set number of formulaic data fields specifiable for each of the three different NCS data sets. It could also have employed more argument groups (e.g., for the filters/constraints) and named arguments.

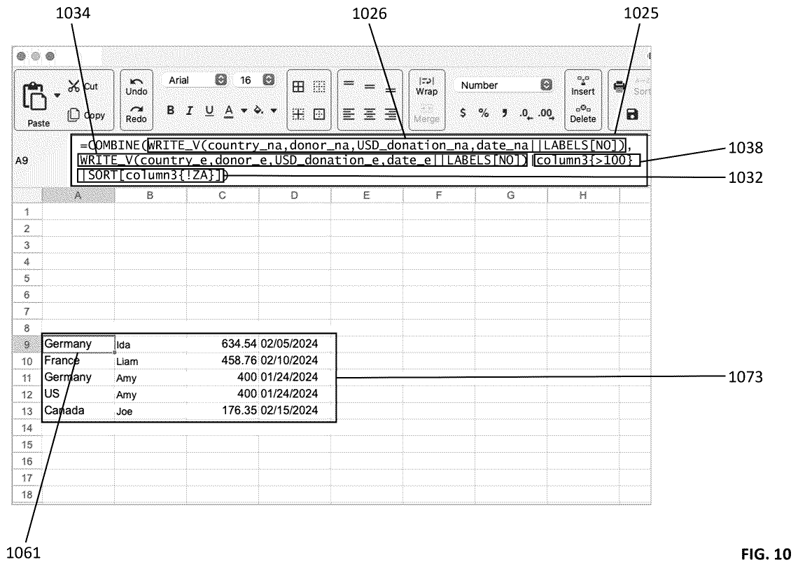

FIG. 10 examples a similar formula as FIG. 9 without the limit argument and with the data in a different order within the formula. Our technology relies on the user ensuring that each of the data set specified inputs fed into our ‘COMBINE’ function match the those of the other data set inputs but gives them the flexibility to input what formulaic data fields they desire in the order desired. In FIG. 10 the user has input four formulaic data fields in each of the two ‘WRITE_V’ functions 1026 and 1034. The filtering is done by the constraint1 argument ‘column3>100’ 1038 and the manually specified override of the first sort is done by the option1 named argument ‘SORT[column 3 {!ZA}]’ 1032 for the formula 1025 populated in the cell ‘A9’ 1061. All giving the results 1073 populated in the cells ‘A9’ through ‘D13’. The automatically executed actions by our spreadsheet application are similar to those illustratively exampled in FIG. 5 except differing by the order of the fields and the lack of a limit.

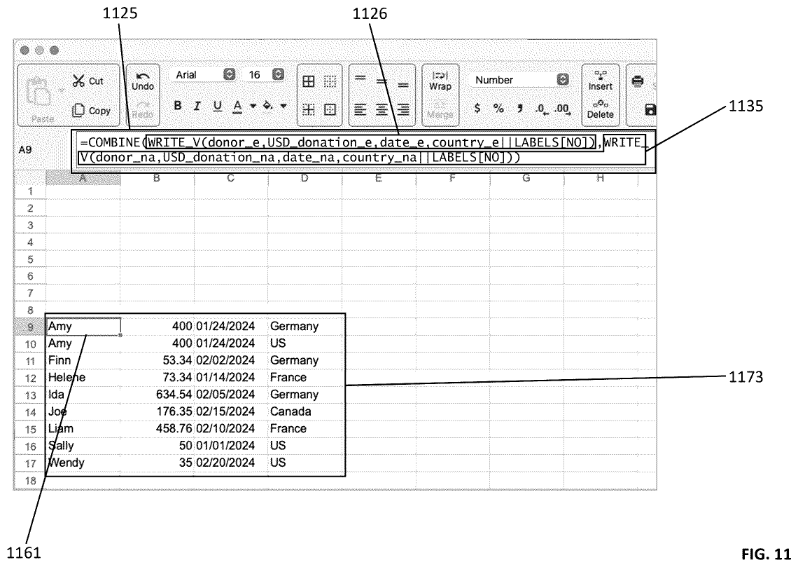

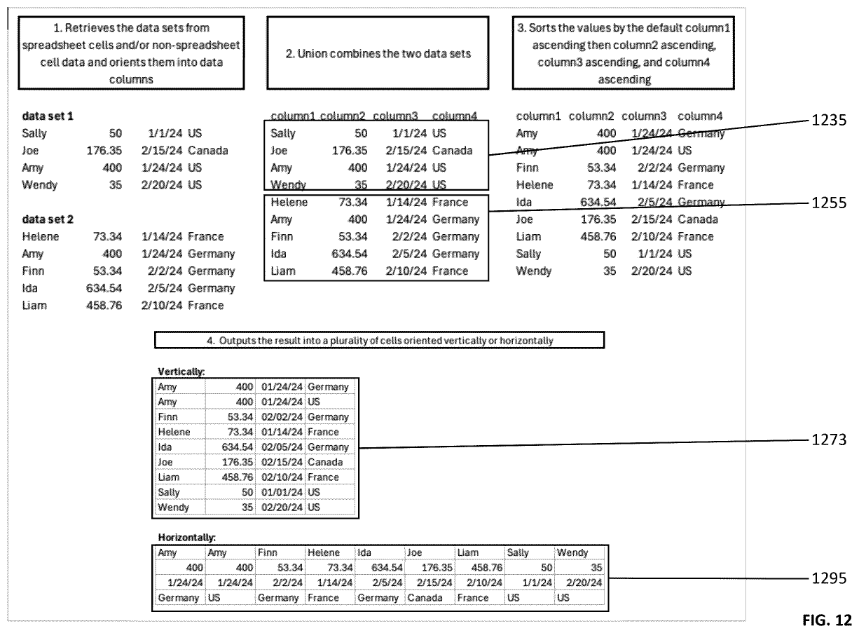

FIG. 11 is a minimum argument example of one of our union combine function where the formula 1125 for cell ‘A9’ 1161 holds only the two required dataset arguments, in this example populated by two ‘WRITE’ functional formulas 1126 and 1135. It populates the values 1173 in cells ‘A9’ through ‘D17’ employing the default sorting for this embodiment. The automatically executed actions are illustratively exampled in FIG. 12. These illustrative actions are meant to example what is done while recognizing our application may accomplish the same outcome in a different manner. Step one retrieves data set 1 and data set 2 in this situation from NSC external data sets like those in FIG. 8A or FIG. 8B and prepares them for the union combination of 1235 and 1255 in step two. Step three then sorts the combined data employing the default sort(s) for this embodiment. In this embodiment the default sort is an ascending multi-sort across the columns in their sequential order. Step four then populates the union combined and sorted values in the default orientation into the spreadsheet cells, where the default orientation in this embodiment is ‘Vertically’ (row major) 1273. Had in this embodiment the user specified an output argument with ‘H’ they would have gotten the ‘horizontally’ (column major) oriented output 1295.

While we could example different syntax, data set, and argument value examples for brevity's sake we will move on to exampling our technology for combinations of in-spreadsheet cell data set(s) and NSC external data sets.

### Combination In-Cell and NCS Data Sets

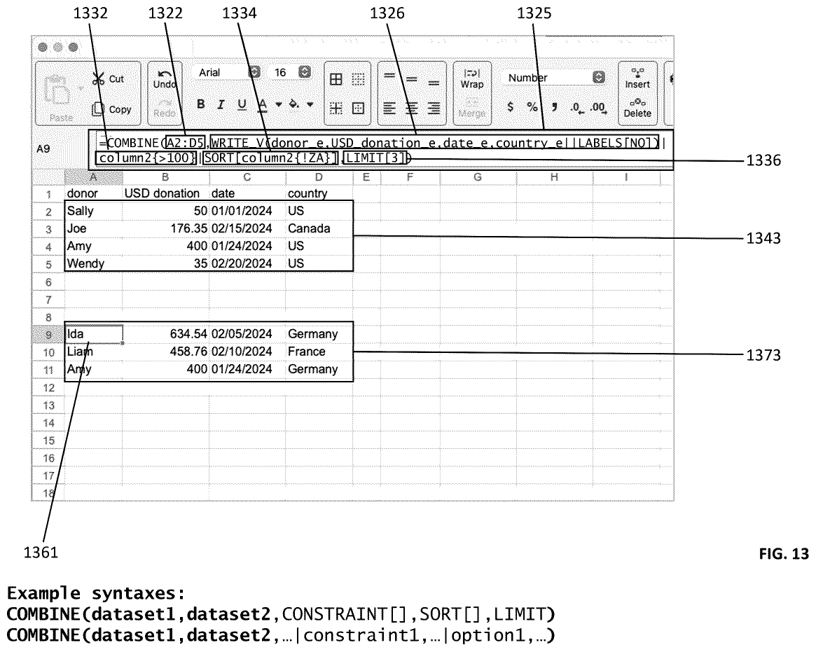

FIG. 13 through FIG. 17 example how our technology applies to a combination of data sets sourced from both in-spreadsheet cell data and NSC external data. FIG. 13 examples the union combination of one in-spreadsheet cell data set 1343 and a second data set sourced from NSC external data like that exampled in FIG. 8A or FIG. 8B. The in-cell data is supplied by the first ‘COMBINE’ function argument ‘A2:D5’ 1322 while the NCS external data is supplied by the ‘WRITE_V’ functional formula 1326 populated in the second argument. The filtering is done by the constraint1 argument ‘column2>100’ 1332, the manually specified override of the first sort is done by the option1 named argument ‘SORT[column2{!ZA}]’ 1334 and the limit of three rows is done by the named argument ‘LIMIT[3] 1336 for the formula 1325 populated in the cell ‘A9’ 1361. It populates the same values 1373 in cells ‘A9’ through ‘D11’ as our previous in-spreadsheet cell example in 973 in FIGS. 9 and 464 in FIG. 4 despite the data sources in those other examples being different. This is because the data vales are the same, just the data set locations are different. FIG. 4 sources the data from two in-spreadsheet cell data sets while FIG. 9 sources the data from two NSC external data sets. The automatically executed actions are exampled in FIG. 5 which were written for any data source and therefore applicable to any of the combinations. The step descriptions are not repeated for brevity's sake.

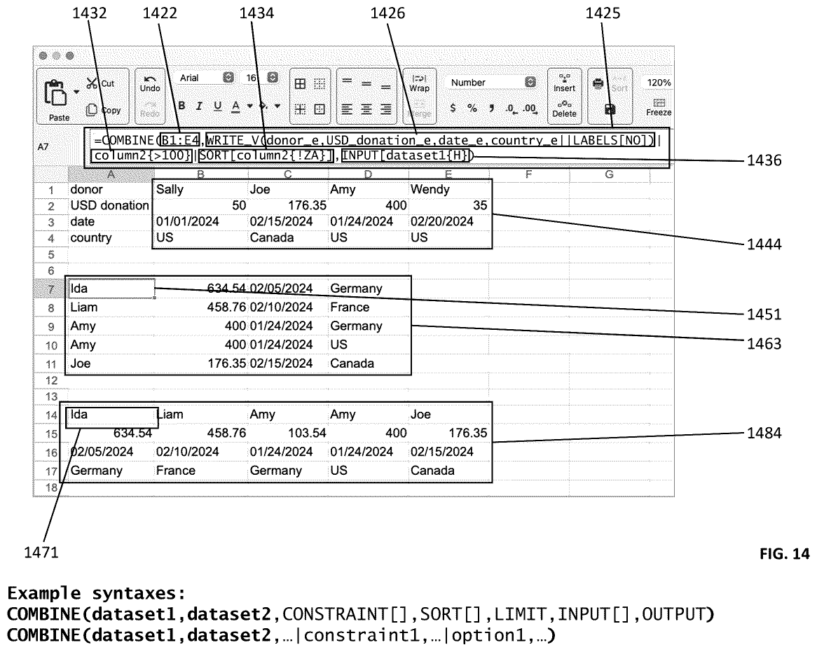

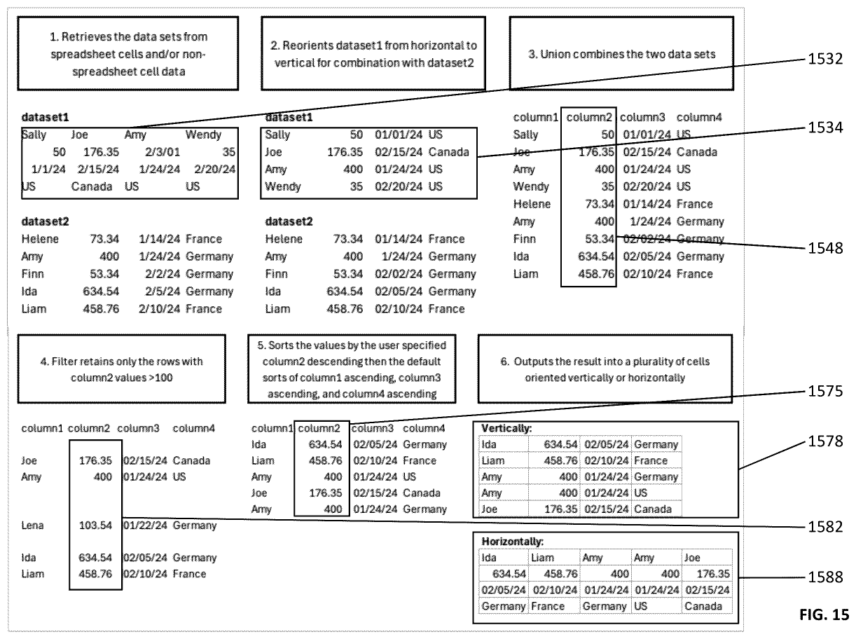

FIG. 14 examples using the same dataset values as FIG. 13 with the difference that the in-spreadsheet cell data 1444 is horizontally oriented rather than vertically oriented (as it was in FIG. 13). In this embodiment this requires the named argument ‘INPUT[dataset1{H}]’ 1436 argument to tell our ‘COMBINE’ function the dataset is not vertically oriented (the default in this embodiment). There are many other ways that could have been handled, horizontal dedicated functions (e.g., COMBINE_H) but this approach allows the user to combine in-spreadsheet cell datasets with different orientations and not tie that orientation of the input data to how the results are outputted. In this example the user has inputted the in-spreadsheet cell dataset ‘B2:E4’ 1422 into the first argument and the NCS external dataset 1426 into the second argument via a ‘WRITE’ function (however, the formulaic data fields that populate dataset2 could be inputted many other ways). Filtering is done by the constraint1 argument ‘column2>100’ 1432 and the manually specified override of the first sort is done by the option1 named argument ‘SORT[column 2{!ZA}]’ 1434 for the formula 1425 populated in the cell ‘A7’ 1451. This populates the values vertically (the default output orientation) in the cells ‘A7’ through ‘D11’ 1463. However, had the formula for this embodiment included an output argument (e.g., named argument OUTPUT[H]) specifying a horizontal output then the user would have gotten the output in ‘A14’ through ‘E17’ 1484 for that formula in cell ‘A14’ 1471. In either situation our application would have automatically executed the illustrative steps in FIG. 15. Where step one retrieves the data from the specified sources, in this example one in-spreadsheet cell horizontally oriented 1532 and one NSC external dataset. Step two reorients the horizontal data source 1532 to vertical 1534 so that it is ready in step three to be union combined. Step four filters (constrains) the data to rows where the column2 values are greater the 100 (1582 versus 1548). Step five then sorts the remaining values (although steps four and five could be reversed) starting with the user specified first sort of column2 descending (‘!ZA’) 1575 and then the default sort of ascending column1, then column3, and finally column4. Recognizing the default sort could be different and may not involve sorting all of the columns. Then step six orients the output either in the default vertical (rows major) 1578 (1463 in FIG. 14) or in this embodiment the user specified horizontal (column major) 1588 (1484 in FIG. 14) putting the values in the appropriate cells.

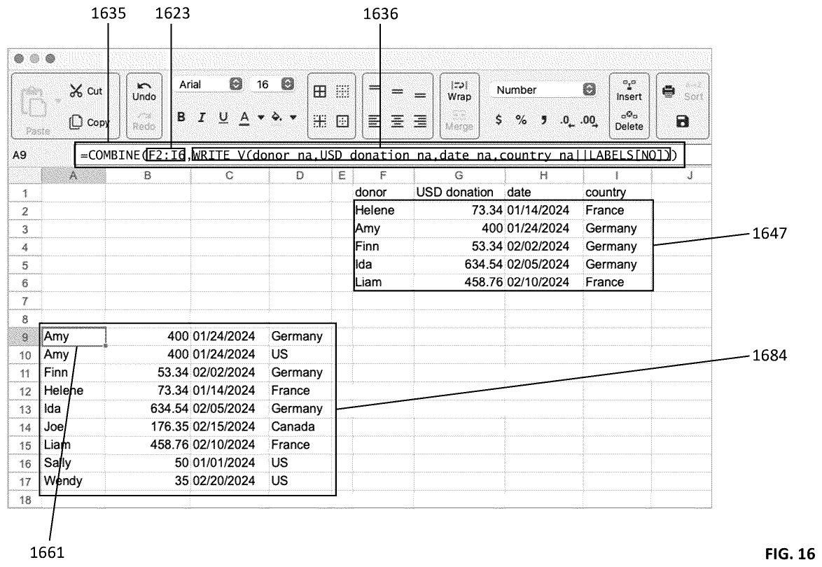

FIG. 16 is a minimum argument example of one of our union combine functions where the formula 1635 for cell ‘A9’ 1661 holds only the two required dataset arguments, in this example one populated from the in-spreadsheet cell data in ‘F2:I6’ 1647 by the argument ‘F2:I6’ 1623 and the other from NCS external data populated by the ‘WRITE’ functional formula 1636. The ‘COMBINE’ function then populates the values 1684 in cells ‘A9’ through ‘D17’ employing the default sorting for this embodiment. As previously illustratively exampled this is automatically done by the actions in FIG. 12 for the vertical output 1273.

While we could example different syntax, data set, and argument value examples for combinations of in-spreadsheet cell and NSC external dataset union combinations, for brevity's sake we will move on to exampling our how our technology applies to combinations of more than two datasets.

### Combination In-Cell and NCS Data Sets

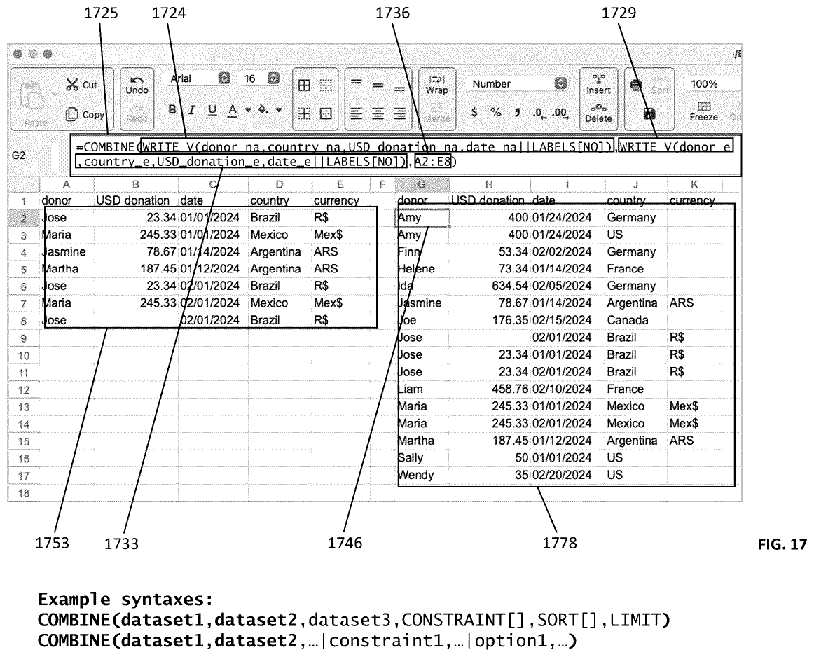

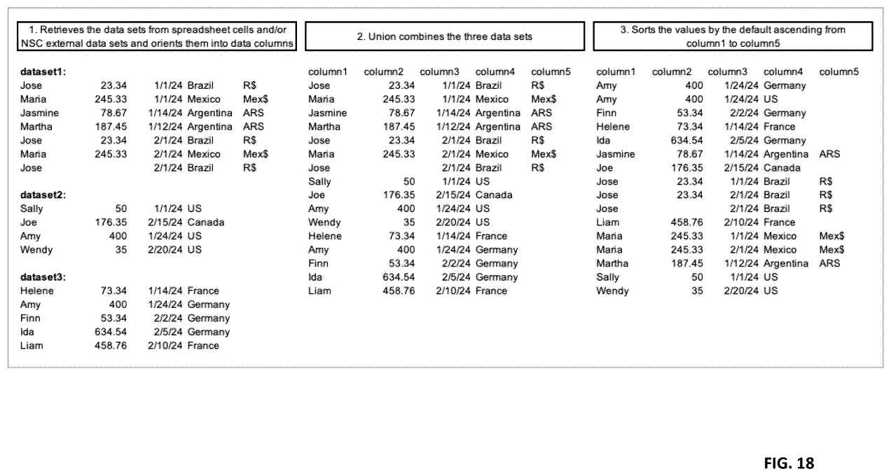

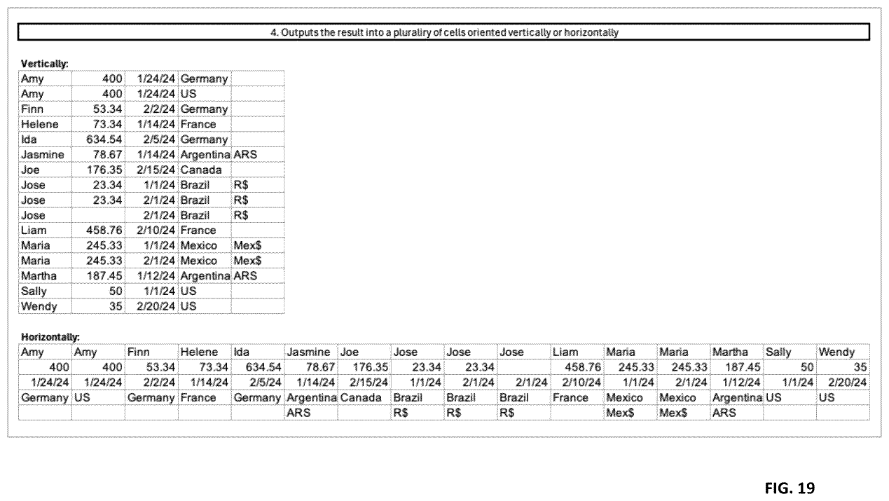

FIG. 17 examples the union combination of three data sets in our technology. One of those data sets is from in-spreadsheet cell data 1753, specified in the ‘COMBINE’ function formula 1725 in cell G2′ 1746 via the third argument ‘A2:E8’ 1736. The other two data sets come from NSC external data sets like those exampled in FIG. 8A and FIG. 8B via the first two ‘COMBINE’ function formula 1725 arguments 1724 and 1729/1733. Both are populated via ‘WRITE’ functional formulas but could have provided via other formulaic data field mechanisms (which populate the field values into the COMBINE function). The result is the output in cells ‘G2’ through ‘K17 ’ 1778 from the formula 1725 in cell ‘G2’ 1746. The automatically executed actions by the formula are illustratively exampled in FIG. 18 and FIG. 19. Step one in FIG. 18 retrieves the data sets from any combination of sources and orients the different data sets so they can be combined. I could include a reorientation of in-cell data as previously described for horizontal data. Then step two union combines the three data sets. Step three sorts the combined data using the default sorts which for this embodiment do an ascending multi-sort starting with the first column working to the last column. Step four in FIG. 19 then outputs the results vertically in this example or horizontally if the user specifies that. Note, while this example in FIG. 17 employed one in-spreadsheet cell data set and two NSC external data sets, our technology supports all three data sets coming from in-spreadsheet cell data sets and all three data sets coming from NSC external data sets.

FIG. 17 through FIG. 19 also exampled the ability of our union combine technology to combine data sets containing different number of data columns (or rows in the horizontal construct). The in-spreadsheet cell data set 1753 in FIG. 17 has five columns of data 1736 inputted into the formula 1725 while the two NCS external data set inputs 1724 and 1729/1733 only have four columns of data as seen in step one in FIG. 18. That does not present a problem, as exampled in FIG. 17 through FIG. 19, to any of the different embodiments of our technology nor any of the data set source combinations.

While we could example different data source combinations of three or more data sets, they operate in manners similar to the examples herein. We have heavily used the same data set values throughout our examples to focus on how the functionality of our technology works the same way across different data sources once the data is retrieved/oriented. We have exampled a number of different functional syntaxes all of which have a defined set of arguments with specified combinations which are not freeform like database (e.g., SQL) or application programming languages (e.g., Python, Microsoft Excel VBA or Google Sheets Google Apps Script). Embodiments of our union combine function employ the traditional fixed argument structure seen in other spreadsheets, the fixed structure optional number of recurring arguments (e.g. SUM) or recurring combination of arguments (e.g., SORTBY), our argument group optional recurring arguments, our named arguments, and combinations of these argument syntaxes/syntax elements. While we could create numerous examples of the combinations of those syntax elements to create our union combine function embodiments, for brevity's sake we will move on to other types of implementation embodiments.

### Other Types of Implementation Embodiments

Other implementations may include a non-transitory computer readable storage medium storing instructions executable by a processor to perform any of the methods described above. Yet another implementation may include a system including memory and one or more processors operable to execute instructions, stored in the memory, to perform any of the methods described above.

In the interest of conciseness, the combinations of features disclosed (e.g., locations of joins, types of joining, validation of joins, join selection lists and joinable data selection lists) in this application have not repeated with each of the other features and in all the possible combinations. The reader will understand how features identified in this section can readily be combined with sets of other features. We will therefore move on to describing one of many example computer systems that can be used for our technology.

### Computer System

FIG. 20 is a block diagram of an example computer system, according to one implementation. Computer system 2010 typically includes at least one processor 2014 which communicates with a number of peripheral devices via bus subsystem 2012. These peripheral devices may include a storage subsystem 2024 including, for example, memory devices 2026 and a file storage subsystem 2028, user interface input devices 2022, user interface output devices 2020, and a network interface subsystem 2016. The input and output devices allow user interaction 2020/2022 and automated interaction 2078 with computer system 2010. Network interface subsystem 2016 provides an interface to outside networks, including an interface to communication network 2085, and is coupled via communication network 2085 to corresponding interface devices in other computer systems or in the cloud and usable for cloud applications.

User interface input devices 2022 may include a keyboard; pointing devices such as a mouse, trackball, touchpad, or graphics tablet; a scanner; a touch screen incorporated into the display; audio input devices such as voice recognition systems and microphones; and other types of input devices. In general, use of the term “input device” is intended to include all possible types of devices and ways to input information into computer system 2010 or onto communication network 2085.

User interface output devices 2020 may include a display subsystem, a printer, a fax machine, or non-visual displays such as audio output devices. The display subsystem may include a touch screen, a flat-panel device such as a liquid crystal display (LCD), a projection device, a cathode ray tube (CRT), or some other mechanism for creating a visible image. The display subsystem may also provide a non-visual display such as via audio output devices. In general, use of the term “output device” is intended to include all possible types of devices and ways to output information from computer system 2010 to the user or to another machine or computer system.

Storage subsystem 2024 stores programming and data constructs that provide the functionality of some or all of the modules and methods described herein. These software modules are generally executed by processor 2014 alone or in combination with other processors.

Memory 2026 used in the storage subsystem can include a number of memories including a main random-access memory (RAM) 2030 for storage of instructions and data during program execution and a read only memory (ROM) 2032 in which fixed instructions are stored. A file storage subsystem 2028 can provide persistent storage for program and data files, and may include a hard disk drive, SSD, a tape drive, an optical drive, or removable media cartridges. The modules implementing the functionality of certain implementations may be stored by file storage subsystem 2028 in the storage subsystem 2024, or in other machines accessible by the processor.

Bus subsystem 2012 provides a mechanism for letting the various components and subsystems of computer system 2010 communicate with each other as intended. Although bus subsystem 2012 is shown schematically as a single bus, alternative implementations of the bus subsystem may use multiple busses.

Computer system 2010 can be of varying types including a workstation, server, computing cluster, blade server, server farm, or any other data processing system or computing device. Due to the ever-changing nature of computers and networks, the description of computer system 2010 depicted in FIG. 20 is intended only as one example. Many other configurations of computer system 2010 are possible having more or fewer components than the computer system depicted in FIG. 20.

### Some Particular Implementations

Some particular implementations and features are described in the following discussion. Implementations of our spreadsheet cell union combine function technology support a broad spectrum of situations sourcing data sets from in-spreadsheet cell and/or non-spreadsheet cell (NSC) external data. Implementations of our technology support single union combine functions that support all the different combinations of in-spreadsheet cell and/or non-spreadsheet cell (NSC) external data for two or more different data sets. Our technology supports a range of different default and user specified combined data sorting as well as filtering (constraining), limiting, input orientations, and output orientations.

### In-Cell and External Data Sets

One implementation of our technology supports a prebuilt union combine spreadsheet function that combines at least one data set employing formulaic data description terms for accessing NSC external sourced data and at least one data set specifying a range of spreadsheet cells to access an in-spreadsheet cell data set. Like other spreadsheet prebuilt functions, it has a structured list of function arguments with predetermined ordering of arguments separated by one or more delimiters. The two or more accessed data sets are then union combined after which the combined data is ascending or descending sorted before being outputted into a range of spreadsheet cells as exampled in FIG. 16 and FIG. 12 for an embodiment with two minimum required arguments FIG. 13 through FIG. 15 and FIG. 17 through FIG. 19 example embodiments or situations with more features.

### External Data Sets

One implementation of our technology supports a prebuilt union combine spreadsheet function that combines at least two data set employing formulaic data description terms for accessing NSC external sourced data. Like other spreadsheet functions, it has a structured list of function arguments with predetermined ordering of arguments separated by one or more delimiters. The two or more accessed data sets are then union combined after which the combined data is ascending or descending sorted before being outputted into a range of spreadsheet cells as exampled in FIG. 11 and FIG. 12 for an embodiment with two minimum required arguments. FIG. 9 and FIG. 10 example embodiments or situations with more features.

### In-Cell Data Sets

One implementation of our technology supports a prebuilt union combine spreadsheet function that combines at least two data sets specifying a range of spreadsheet cells to access in-spreadsheet cell data. Like other spreadsheet prebuilt functions, it has a structured list of function arguments with predetermined ordering of arguments separated by one or more delimiters. The two or more accessed data sets are then union combined after which the combined data is ascending or descending sorted before being outputted into a range of spreadsheet cells as exampled in FIG. 6 and FIG. 12 for an embodiment with two minimum required arguments. FIG. 4 and FIG. 5 example embodiments or situations with more features.

### All Implementations

All of the previously mentioned implementations share a similar set of additional implementations that for brevity's sake will be described together with the occasion noting of any limitation to applicability. Additionally, most if not all single implementations (embodiments) can support all the combinations of data set sources, making usage more convenient for users.

### Input Orientation

Implementations including in-spreadsheet cell data include the capability to reorient any horizontal (column major) data ranges to vertical (row major) for union combination with any vertical data sets (e.g., in-spreadsheet cell-oriented row major data or NCS external data set table sourced data) as exampled in FIG. 14 and specifically exampled in FIG. 15 step two 1534 versus step one 1532.

### Data Set Inputs

Implementations include different ways to input the in-spreadsheet cell and NCS external data sets. In-spreadsheet cell data set inputs can be done as a single range as exampled in FIG. 4 through FIG. 6 and FIG. 13 through FIG. 19 or can be input as more than one range per data set as exampled in FIG. 20 through FIG. 23. The non-spreadsheet cell external data sets can be specified various different ways (e.g., by themselves or within a function such as our table generation functions) formulaic data field by formulaic data field as exampled in FIG. 9 through FIG. 19 or they could be specified by an external database table name employing all the columns of data within the data table.

### Argument Groups

Variants of the implementations include union combine functions employing a functional syntax including groups of arguments, as described in our previous filings, where each argument group is separated from another argument group by a second delimiter (e.g.‘|’) and containing arguments within the argument group separated by a first delimiter (e.g., ‘,’). Thereby having a predetermined order of the argument groups within which there is a variable number of arguments (e.g., some required and some optional or all optional). Those variable number of arguments can be of the same type varying in number, like the number of ‘number’ arguments can vary in a SUM function, they can be set of defined arguments or named arguments where some are optional, or the entire argument group can be optional and populated or not populated as exampled in FIG. 4, FIG. 9, FIG. 13, and FIG. 14 and the various syntaxes described herein.

### Named Argument

Variants of the implementations include named arguments within regular single delimiter arguments and/or within two delimiter argument groups as exampled in many of the union combination prebuilt function syntaxes discussed herein and exampled in FIG. 4, FIG. 9, FIG. 13, and FIG. 14. Those named arguments can contain a single argument, e.g.,'3′ in LIMIT[3], or can contain multiple arguments separated by a delimiter, e.g., the three arguments separated by commas in SORT[column2{!ZA}, column1{!AZ}, column3{!ZA}] or the three arguments separated by commas in CONSTRAINT[column2{>100}, column1{<“h”}}, column3{‘1/1/24’. . . ‘1/31/24’}].

### Filter/Constraint

Variants of the implementations further include applying constraints/filters to the union combined data by user specified vertical column or horizontal row value constraints as exampled in FIG. 4, FIG. 9, FIG. 10, FIG. 13, and FIG. 14.

### Limit

Variants of the implementations further include applying a row major row limit or a column major column limit to the output from the union combine prebuilt functional formula as exampled in FIG. 4 474/484, FIG. 9, and FIG. 13.

### More Than Two Data Sets

Variants of the implementations further include three or more data sets accessed to be union combined, where the data sets can be all in-spreadsheet cell sourced, where they can all be NSC external data sourced, or where they can be a combination of in-spreadsheet cell sourced and NSC external data sourced as exampled in FIG. 17 through FIG. 19.

### Sorting

Variants of the implementations support all numbers of sorts (e.g., multi-sorts) and all combinations of prebuilt union combine function default sorts and user specified sorts. So, where there is a single sort and where there are multi-sorts. Where those sorts are entirely user specified, all default application specified, or a combination of both. Where the multi-sort

column or row sort order is user, default, or partially user and partially default specified and

where the ascending or descending order of the value sort is user, default, or partially user and partially default specified as discussed herein and exampled in FIG. 4 through FIG. 6 and FIG. 9 through FIG. 19.

### Formulaic Data

Variants of the implementations support different ways of accessing the NCS external data. They can be accessed via table and field names, unique field names directly or via other of our technology functions such as the table generation functions (e.g., WRITE_V) as described in syntax variants herein or exampled in FIG. 9, FIG. 10, FIG. 12 step one, FIG. 13, FIG. 14, FIG. 15 step one, FIG. 16, FIG. 17, and FIG. 18 step one.

### Output Orientation

Variants of the implementations support vertical or horizontal output orientations of the results of the union combined prebuilt spreadsheet function formula as exampled for row major vertical orientation in FIG. 4, FIG. 6, FIG. 9, FIG. 10, FIG. 11, FIG. 13, FIG. 14 1463, FIG. 16, and FIG. 17 and exampled in column major horizontal orientation in FIG. 5 588, FIG. 12 1295, FIG. 14 1484/FIG. 15 1588, and FIG. 19.

### Other Implementations

Other implementations may include a non-transitory computer readable storage medium storing instructions executable by a processor to perform any of the methods described above. Yet another implementation may include a system including memory and one or more processors operable to execute instructions, stored in the memory, to perform any of the methods described above.

While the technology disclosed is disclosed by reference to the embodiments and examples detailed above, it is to be understood that these examples are intended in an illustrative rather than in a limiting sense. It is contemplated that modifications and combinations will readily occur to those skilled in the art, which modifications and combinations will be within the spirit of the innovation and the scope of the following clauses and claims.

### CLAUSES

### In-Cell and External Data Sets

1. A method of combining data in a spreadsheet using a prebuilt spreadsheet function that union combines and then sorts the data from different data sets, including:
   accessing from the spreadsheet the data combination function entered in a first spreadsheet cell, wherein the data combination function;
   receiving arguments in a structured arguments list of the data combination function, which structured arguments list has a predetermined ordering of arguments separated by delimiters, the arguments including:
      at least one each of a first and a second user specified data set, wherein:
         a first argument for at least one first user specified data set includes formulaic data description terms for accessing two or more non-spreadsheet sourced data fields; and
         a second argument for at least one second data set data set argument includes specification of a spreadsheet cell range for accessing two or more spreadsheet cell sourced data fields;
      wherein the first and the second user specified data sets have data fields in matching order; the data combination function executing and union combining the first and second user specified
      data sets data, and then sorting the combined data based on values of the data fields; and outputting for display the combined and sorted data into a plurality of spreadsheet cells.

### External Data Sets

2. A method of combining data in a spreadsheet using a prebuilt spreadsheet function that union combines and then sorts the data from different data sets, including:
   accessing from the spreadsheet the data combination function entered in a first spreadsheet cell, wherein the data combination function;
   receiving arguments in a structured arguments list of the data combination function, which structured arguments list has a predetermined ordering of arguments separated by delimiters, the arguments including:
      at least one each of a first and a second user specified data set, wherein:
         a first argument for at least one first user specified data set includes formulaic data description terms for accessing two or more non-spreadsheet sourced data fields; and
         a second argument for at least one second data set data set argument includes formulaic data description terms for accessing two or more non-spreadsheet sourced data fields;
      wherein the first and the second user specified data sets have data fields in matching order; the data combination function executing and union combining the first and second user specified data sets data, and then sorting the combined data based on values of the data fields; and outputting for display the combined and sorted data into a plurality of spreadsheet cells.

### In-Cell Data Sets

3. A method of combining data in a spreadsheet using a prebuilt spreadsheet function that union combines and then sorts the data from different data sets, including:
   accessing from the spreadsheet the data combination function entered in a first spreadsheet cell, wherein the data combination function;
   receiving arguments in a structured arguments list of the data combination function, which structured arguments list has a predetermined ordering of arguments separated by delimiters, the arguments including:
      at least one each of a first and a second user specified data set, wherein:
         a first argument for at least one first user specified data set includes specification of a spreadsheet cell range for accessing two or more spreadsheet cell sourced data fields; and
         a second argument for at least one second data set data set argument includes specification of a spreadsheet cell range for accessing two or more spreadsheet cell sourced data fields;
      wherein the first and the second user specified data sets have data fields in matching order; the data combination function executing and union combining the first and second user specified
      data sets data, and then sorting the combined data based on values of the data fields; and outputting for display the combined and sorted data into a plurality of spreadsheet cells.

### Input Orientation

4. The method of clause 1, wherein the cell sourced data is organized in column major order, further including transposing the cell sourced data into row major order for combination with the non-spreadsheet sourced data.
5. The method of clause 3, wherein at least one of the cell sourced data sets is organized in column major order and at least one of the cell sourced data sets is organized in row major order, further including transposing as needed the cell sourced data into all row major order or all column major for combination of the data sets.

### Data Set Inputs

6. The method of clauses 1 and 3, wherein the specification of one or more in-spreadsheet cell data set is composed of more than one range of cells.
7. The method of clauses 1 and 2, wherein the specification of one or more non spreadsheet cell data set is composed of individual formulaic data fields.

### Argument Groups

8. The method of clauses 1, 2, and 3, further including the structured argument list contains arguments grouped within argument groups wherein the predetermined argument order places arguments within specific argument groups and one type of delimiter separates argument groups and a second type of delimiter separates arguments within an argument group.
9. The method of clause 6, wherein the argument group accommodates different numbers of like arguments within argument group.

### Named Arguments

10. The method of clause 6, wherein one or more arguments employ named arguments.
11. The method of clauses 1, 2, and 3, wherein one or more arguments employ named arguments.
12. The method of clauses 11, wherein the named argument contains multiple arguments within its delimiters.

### Filter/Constraint

13. The method of clauses 1, 2, and 3, further including applying constraints to filter the union combined and sorted results by user specified data row major or column major output spreadsheet function filtering argument(s).

### Limit

14. The method of clauses 1, 2, and 3, further including limiting output of results from the data combination spreadsheet function responsive to a user specified data combination spreadsheet function argument count of items to output.
15. The method of clause 14, wherein the count of items is the count of row major rows of data to output or the count of column major columns to output.

### More Than Two Data Sets

16. The method of clauses 1, 2, and 3, further including three or more data sets to be combined and sorted.

### Sorting

17. The method of clauses 1, 2, and 3, wherein the sort order is user selected.
18. The method of clauses 1, 2, and 3, wherein the sort order is an application default.
19. The method of clause 1, 2, and 3, wherein the sort order is a combination of user selection and application default.

### Formulaic Data

20. The method of clauses 1 and 2, wherein the non-spreadsheet cell sourced data argument or arguments are specified by a table generation prebuilt spreadsheet function employing the formulaic data.

### Output Orientation

21. The method of clauses 1, 2, and 3, wherein the columns of the union combined and sorted data is output in a plurality of spreadsheet cells organized by row major order.
22. The method of clauses 1, 2, and 3, wherein the columns of the union combined and sorted data is output in a plurality of spreadsheet cells organized by column major order.

### Other Implementations

23. A non-transitory computer readable memory, the memory impressed with computer instructions that, when executed on hardware, cause the hardware to carry out the method of any of clauses 1-22.
24. A system including processing hardware coupled to memory, the memory impressed with computer instructions that, when executed, cause the hardware to carry out the method of any of clauses 1-22.

We claim as follows:

1. A method of combining data in a spreadsheet using a prebuilt spreadsheet function that union combines and then sorts the data from different data sets, including:
accessing from the spreadsheet a data combination function entered in a first spreadsheet cell;
receiving arguments in a structured arguments list of the data combination function, which structured arguments list has a predetermined ordering of arguments separated by delimiters, the arguments including at least one each of a first and a second user specified data set, wherein:
a first argument for at least one first user specified data set includes formulaic data description terms for accessing two or more non-spreadsheet sourced data fields; and
a second argument for at least one second data set data set argument includes specification of a spreadsheet cell range for accessing two or more spreadsheet cell sourced data fields;
wherein the first and the second user specified data sets have data fields in matching order;
the data combination function executing and union combining the first and second user specified data sets data, and then sorting the combined data based on values of the data fields; and
outputting for display the combined and sorted data into a plurality of spreadsheet cells.

2. The method of claim 1, wherein the cell sourced data is organized in column major order, further including transposing the cell sourced data into row major order for combination with the non-spreadsheet sourced data.

3. The method of claim 1, further including the structured argument list contains arguments grouped within argument groups wherein the predetermined argument order places arguments within specific argument groups and one type of delimiter separates argument groups and a second type of delimiter separates arguments within an argument group.

4. The method of claim 3, wherein the argument group accommodates different numbers of like arguments within argument group.

5. The method of claim 3, wherein one or more arguments employ named arguments.

6. The method of claim 1, wherein one or more arguments employ named arguments.

7. The method of claim 6, wherein the named argument contains multiple arguments within its delimiters.

8. The method of claim 1, wherein the specification of one or more in-spreadsheet cell data set is composed of more than one range of cells.

9. The method of claim 1, further including applying constraints to filter the union combined and sorted results by user specified data column output spreadsheet function filtering argument(s).

10. The method of claim 1, further including limiting output of results from the data combination function responsive to a function argument count of items to output from the user specified data combination.

11. The method of claim 10, wherein the count of items is the count of row major rows of data to output or the count of column major columns to output.

12. The method of claim 1, further including three or more data sets to be union combined and sorted.

13. The method of claim 1, wherein the sort order is user selected.

14. The method of claim 1, wherein the sort order is an application default.

15. The method of claim 1, wherein the sort order is a combination of user selection and application default.

16. The method of claim 1, wherein the non-spreadsheet sourced data argument or arguments are specified by a table generation prebuilt spreadsheet function employing the formulaic data.

17. The method of claim 1, wherein columns of the union combined and sorted data are output in a plurality of spreadsheet cells organized by row major order.

18. The method of claim 1, wherein columns of the union combined and sorted data are output in a plurality of spreadsheet cells organized by column major order.

19. A non-transitory computer readable medium holding instructions that, when executed on hardware, configure the hardware to implement a method of combining data in a spreadsheet using a prebuilt spreadsheet function that union combines and then sorts the data from different data sets, including:
accessing from the spreadsheet a data combination function entered in a first spreadsheet cell;
receiving arguments in a structured arguments list of the data combination function, which structured arguments list has a predetermined ordering of arguments separated by delimiters, the arguments including at least one each of a first and a second user specified data set, wherein:
a first argument for at least one first user specified data set includes formulaic data description terms for accessing a non-spreadsheet sourced data; and
a second argument for at least one second data set data set argument includes specification of a spreadsheet cell range for accessing spreadsheet cell sourced data;
wherein the first and the second user specified data sets have data fields in matching order;
the data combination function executing and union combining the first and second user specified data sets data, and then sorting the combined data based on values of the data fields; and
outputting for display the combined and sorted data into a plurality of spreadsheet cells.

20. The non-transitory computer readable medium of claim 19 holding instructions that, when executed on hardware, configure the hardware to implement the method, further including the structured argument list contains arguments grouped within argument groups wherein the predetermined argument order places arguments within specific argument groups and one type of delimiter separates argument groups and a second type of delimiter separates arguments within an argument group.

21. The non-transitory computer readable medium of claim 19 holding instructions that, when executed on hardware, configure the hardware to implement the method, wherein one or more arguments employ named arguments.

22. The non-transitory computer readable medium of claim 19 holding instructions that, when executed on hardware, configure the hardware to implement the method, further including applying constraints to filter the union combined and sorted results by user specified data column output spreadsheet function filtering argument(s).

23. A system including processing hardware coupled to memory, the memory impressed with computer instructions that, when executed, cause the hardware to carry out a method of combining data in a spreadsheet using a prebuilt spreadsheet function that union combines and then sorts the data from different data sets, including:
accessing from the spreadsheet the data combination function entered in a first spreadsheet cell;
receiving arguments in a structured arguments list of a data combination function, which structured arguments list has a predetermined ordering of arguments separated by delimiters, the arguments including at least one each of a first and a second user specified data set, wherein:
a first argument for at least one first user specified data set includes formulaic data description terms for accessing a non-spreadsheet sourced data; and
a second argument for at least one second data set data set argument includes specification of a spreadsheet cell range for accessing spreadsheet cell sourced data;
wherein the first and the second user specified data sets have data fields in matching order;
the data combination function executing and union combining the first and second user specified data sets data, and then sorting the combined data based on values of the data fields; and
outputting for display the combined and sorted data into a plurality of spreadsheet cells.

24. The system of claim 23, further including the structured argument list contains arguments grouped within argument groups wherein the predetermined argument order places arguments within specific argument groups and one type of delimiter separates argument groups and a second type of delimiter separates arguments within an argument group.

25. The system of claim 23, wherein one or more arguments employ named arguments.
